(19) United States
(12) Patent Application Publication
(10) Pub. No.: US 2021/0197516 A1
(43) Pub. Date: Jul. 1, 2021

(54) LAMINATE

(71) Applicant: FUJIFILM Corporation, Tokyo (JP)

(72) Inventor: Junji KAWAGUCHI, Tokyo (JP)

(73) Assignee: FUJIFILM Corporation, Tokyo (JP)

(21) Appl. No.: 17/197,649

(22) Filed: Mar. 10, 2021

Related U.S. Application Data
(63) Continuation of application No. PCT/JP2019/035519, filed on Sep. 10, 2019.

(30) Foreign Application Priority Data
Sep. 26, 2018 (JP) 2018-180746

(51) Int. Cl. B32B 3/26; B32B 15/20; B32B 15/09; B32B 27/36

(52) U.S. Cl. CPC B32B 3/266; B32B 15/20; C23F 1/04; B32B 27/36; B32B 15/09

(57) ABSTRACT

An object of the present invention is to provide a laminate having high scratch resistance, weather fastness and solvent resistance, and capable of achieving both light-transmitting properties and metallic luster. The laminate includes a metal foil having a plurality of through-holes that pass through in a thickness direction; and a protective layer provided on at least one surface of the metal foil, in which the protective layer contains a metal oxide, the metal foil has an average opening diameter of the through-holes of 0.1 μm to 100 μm and an average opening ratio, which is determined by the through-holes, of 0.1% to 90%, and the protective layer has a light transmittance of 10% or more.

### CROSS-REFERENCE TO RELATED APPLICATIONS

This application is a Continuation of PCT International Application No. PCT/JP2019/035519 filed on Sep. 10, 2019, which claims priority under 35 U.S.C. § 119(a) to Japanese Patent Application No. 2018-180746 filed on Sep. 26, 2018. The above application is hereby expressly incorporated by reference, in its entirety, into the present application.

### BACKGROUND OF THE INVENTION

### 1. Field of the Invention

The present invention relates to a laminate of a metal foil and a protective layer.

### 2. Description of the Related Art

Conventionally, it has been known that the decorativeness of a resin molded article is enhanced by vapor deposition of a metal on a surface of the resin molded article to give it a metallic luster and thus making it have a metallic tone or a half-mirror tone. However, since a metal does not transmit light, light-transmitting properties cannot be obtained in a case where the metal is vapor-deposited to give a metallic luster.

On the other hand, there has been proposed a composite capable of imparting a new design having a metallic tone and light-transmitting properties by imparting a plurality of fine through-holes to a metal foil.

For example, WO2017/150099A discloses a composite for forming a metal-like decorative body including an aluminum base material having a plurality of through-holes in a thickness direction and a resin layer provided on at least one surface of the aluminum base material, in which an average opening diameter of the through-holes is 0.1 to 100 μm and an average opening ratio determined by the through-holes is 1% to 50%.

### SUMMARY OF THE INVENTION

However, in a case where such a composite is used outdoors or the like and then in a case where the metal is exposed, scratch resistance, weather fastness, solvent resistance, and the like become problems. In the composite disclosed in WO2017/150099A, the aluminum base material is protected by providing a resin layer on the surface of the aluminum base material, but in a case where the resin layer is provided on the surface of the metal foil, the texture may change and the metallic luster may be impaired. The metallic luster can be obtained by reducing the thickness of the resin layer, but there is a risk that scratch resistance, weather fastness, solvent resistance, and the like may be deteriorated.

Accordingly, an object of the present invention is to provide a laminate having high scratch resistance, weather fastness and solvent resistance, and capable of achieving both light-transmitting properties and metallic luster.

The present invention achieves the object by the following configurations.

[1] A laminate comprising:

a metal foil having a plurality of through-holes that pass through in a thickness direction; and

a protective layer provided on at least one surface of the metal foil,

in which the protective layer contains a metal oxide,

the metal foil has an average opening diameter of the through-holes of 0.1 μm to 100 μm and an average opening ratio, which is determined by the through-holes, of 0.1% to 90%, and

the protective layer has a light transmittance of 10% or more.

[2] The laminate according to [1], in which the protective layer is provided on one surface of the metal foil, and

the laminate has a resin layer provided on a surface of the metal foil opposite to the surface on which the protective layer is provided.

[3] The laminate according to [1] or [2], in which a content of the metal oxide in the protective layer is 60% by mass or more with respect to a total mass of the protective layer.

[4] The laminate according to any one of [1] to [3], in which the protective layer is formed by a sol-gel method.

[5] The laminate according to any one of [1] to [4], in which the protective layer has an average thickness of 0.01 μm to 10 μm.

[6] The laminate according to any one of [1] to [5], in which the metal foil has an average thickness of 5 μm to 1,000 μm.

[7] The laminate according to any one of [1] to [6], in which the metal foil is a foil selected from the group consisting of an aluminum foil, a copper foil, a silver foil, a gold foil, a platinum foil, a stainless steel foil, a titanium foil, a tantalum foil, a molybdenum foil, a niobium foil, a zirconium foil, a tungsten foil, a beryllium copper foil, a phosphor bronze foil, a brass foil, a nickel silver foil, a tin foil, a lead foil, a zinc foil, a solder foil, an iron foil, a nickel foil, a Permalloy foil, a nichrome foil, an Alloy 42 foil, a Kovar foil, a Monel foil, an Inconel foil, and a Hastelloy foil, or a foil obtained by laminating a foil selected from the above group and a metal of a type different from the selected foil.

As will be described hereinafter, according to an aspect of the present invention, it is possible to provide a laminate having high scratch resistance, weather fastness and solvent resistance, and capable of achieving both light-transmitting properties and metallic luster.

### BRIEF DESCRIPTION OF THE DRAWINGS

FIG. 1 is a schematic top view showing an example of a laminate of the present invention.

FIG. 2 is a cross-sectional view taken along a line B-B in FIG. 1.

FIG. 3 is a schematic cross-sectional view showing another example of the laminate of the present invention.

FIG. 4 is a schematic cross-sectional view showing another example of the laminate of the present invention.

FIG. 5 is a schematic cross-sectional view for explaining a suitable example of a method for producing a metal foil having through-holes used in the laminate of the present invention.

FIG. 6 is a schematic cross-sectional view for explaining a suitable example of a method for producing a metal foil.

FIG. 7 is a schematic cross-sectional view for explaining a suitable example of the method for producing a metal foil.

FIG. 8 is a schematic cross-sectional view for explaining a suitable example of the method for producing a metal foil.

FIG. 9 is a schematic cross-sectional view for explaining another example of the method for producing a metal foil.

FIG. 10 is a schematic cross-sectional view for explaining another example of the method for producing a metal foil.

FIG. 11 is a schematic cross-sectional view for explaining another example of the method for producing a metal foil.

FIG. 12 is a schematic cross-sectional view for explaining another example of the method for producing a metal foil.

FIG. 13 is a schematic cross-sectional view for explaining another example of the method for producing a metal foil.

FIG. 14 is a schematic cross-sectional view for explaining another example of the method for producing a metal foil.

FIG. 15 is a schematic cross-sectional view for explaining another example of the method for producing a metal foil.

FIG. 16 is a schematic cross-sectional view for explaining another example of the method for producing a metal foil.

FIG. 17 is a schematic cross-sectional view for explaining another example of the method for producing a metal foil.

FIG. 18 is a schematic cross-sectional view for explaining another example of the method for producing a metal foil.

FIG. 19 is a schematic cross-sectional view for explaining another example of the method for producing a metal foil.

FIG. 20 is a schematic cross-sectional view for explaining another example of the method for producing a metal foil.

FIG. 21 is a schematic cross-sectional view for explaining another example of the method for producing a metal foil.

FIG. 22 is a schematic cross-sectional view for explaining another example of the method for producing a metal foil.

FIG. 23 is a schematic cross-sectional view for explaining another example of the method for producing a metal foil.

FIG. 24 is a schematic cross-sectional view for explaining another example of the method for producing a metal foil.

FIG. 25 is a schematic cross-sectional view for explaining another example of the method for producing a metal foil.

FIG. 26 is a schematic cross-sectional view for explaining another example of the method for producing a metal foil.

### DESCRIPTION OF THE PREFERRED EMBODIMENTS

Hereinafter, the present invention will be described in detail.

The description of the constituent elements described below may be made based on a typical embodiment of the present invention, but the present invention is not limited to such an embodiment.

In the present specification, a numerical range represented by “to” means a range including the numerical values before and after “to” as a lower limit value and an upper limit value, respectively.

[Laminate]

The laminate according to the embodiment of the present invention is a laminate including a metal foil having a plurality of through-holes that pass through in a thickness direction; and a protective layer provided on at least one surface of the metal foil, in which the protective layer contains a metal oxide, the metal foil has an average opening diameter of the through-holes of 0.1 μm to 100 μm and an average opening ratio, which is determined by the through-holes, of 0.1% to 90%, and the protective layer has a light transmittance of 10% or more.

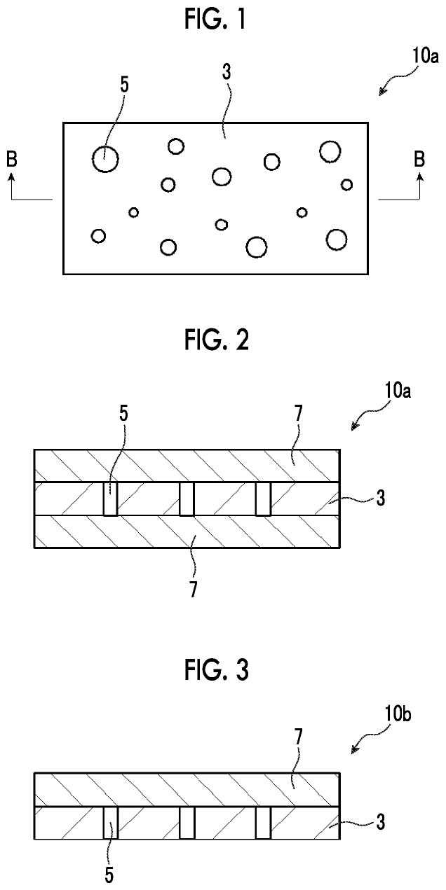

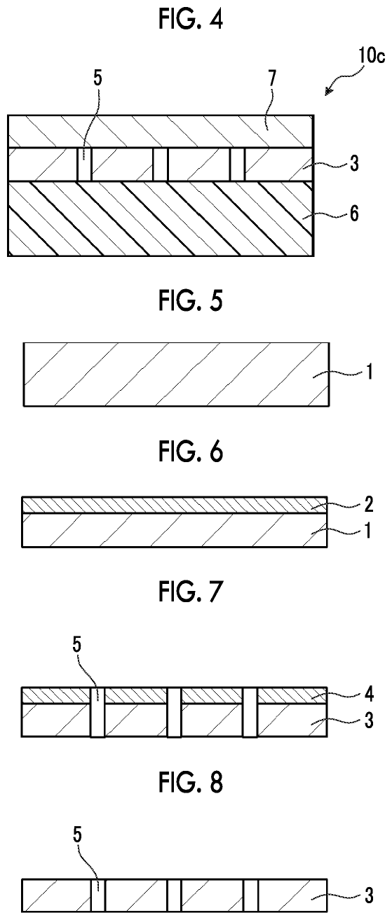

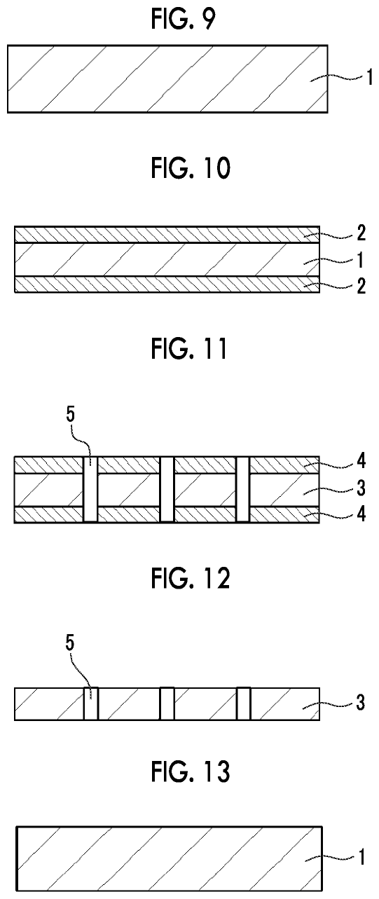

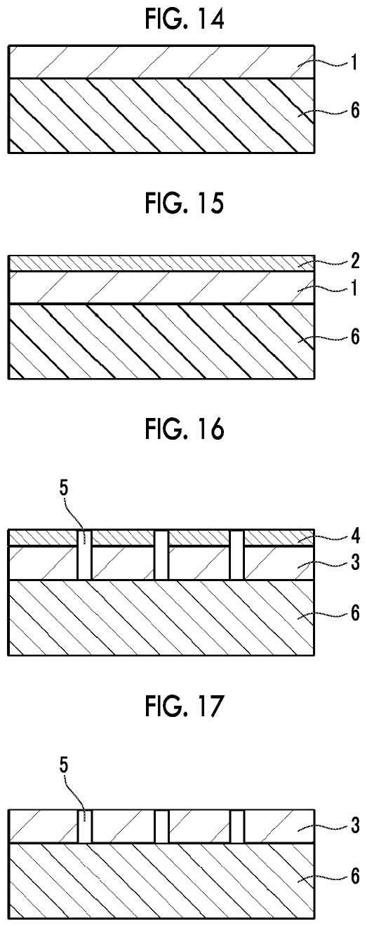

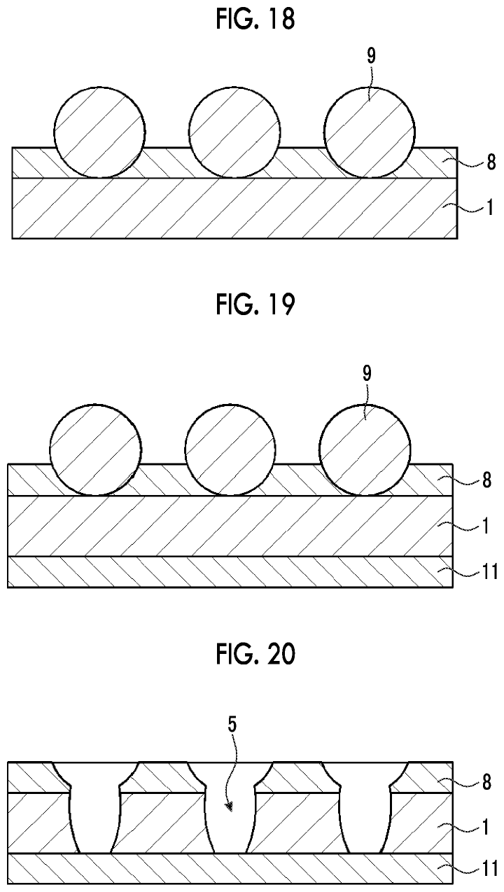

The configuration of the laminate according to the embodiment of the present invention will be described with reference to FIG. 1 and FIG. 2.

FIG. 1 is a front view schematically showing an example of the laminate according to the embodiment of the present invention. FIG. 2 is a cross-sectional view taken along a line B-B in FIG. 1.

A laminate 10a shown in FIG. 1 and FIG. 2 has a metal foil 3 having a plurality of through-holes 5 that pass through in a thickness direction, and two protective layers 7 that are provided on both surfaces of the metal foil 3.

In the present invention, the metal foil 3 has an average opening diameter of the plurality of the through-holes 5 of 0.1 μm to 100 μm and an average opening ratio, which is determined by the through-holes 5, of 0.1% to 90%.

In addition, in the present invention, the protective layer 7 contains a metal oxide and has a light transmittance of 10% or more.

The laminate according to the embodiment of the present invention is excellent in both appearance (metallic luster) and light-transmitting properties, and can be enhanced in scratch resistance, weather fastness, and solvent resistance by including a metal foil in which the average opening diameter and the average opening ratio of the through-holes are within the above-mentioned ranges and a protective layer provided on at least one surface of the metal foil.

Although the reason for such an effect is not clear in detail, the present inventors speculate as follows.

That is, it is considered that, in a case where the average opening diameter and the average opening ratio of the through-holes present in the metal foil are within the above-mentioned ranges, it becomes difficult to visually confirm the presence of the through-holes, while visible light can pass through the through-holes, and therefore, the light could be transmitted without impairing the appearance such as metallic luster.

In addition, by including a protective layer containing a metal oxide, it is possible to prevent the metal foil from being exposed and prevent the metal foil from being scratched or adhering to a solvent or the like, whereby scratch resistance, weather fastness, and solvent resistance can be improved. In addition, since the protective layer contains a metal oxide, scratch resistance, weather fastness, and solvent resistance can be obtained even in a case where the thickness of the protective layer is reduced, whereby the change in texture can be reduced and a sufficient metallic luster can be obtained even in a case where the protective layer is provided on the surface of the metal foil.

In addition, by setting the light transmittance of the protective layer to 10% or more, the protective layer can also transmit light and therefore the light-transmitting properties can be ensured as a laminate.

Here, the laminate 10a shown in FIG. 2 has a configuration in which the hole wall surface of the through-hole 5 has a surface perpendicular to the surface of the metal foil 3, but the present invention may take a configuration in which the hole wall surface of the through-hole 5 has a concavo-convex shape.

In addition, the laminate 10a shown in FIG. 2 has protective layers 7 on both surfaces of the metal foil 3, but the present invention is not limited thereto. For example, the laminate according to the embodiment of the present invention may have a configuration in which the protective layer 7 is provided on one surface of the metal foil 3, as in a laminate 10b shown in FIG. 3, or may have a configuration in which the protective layer 7 is provided on one surface of the metal foil 3 and a resin layer 6 is provided on the other surface of the metal foil 3, as in a laminate 10c shown in FIG. 4.

In a case where it is not necessary to distinguish the laminates 10a to 10c in the following description, these laminates are collectively referred to as the laminate 10.

[Metal Foil]

The metal foil 3 is a foil having a plurality of through-holes 5 and composed of a metal and/or a metal compound.

The average opening diameter of the through-holes 5 of the metal foil 3 is 0.1 μm to 100 μm.

In addition, the average opening ratio determined by the through-holes 5 is 0.1% to 90%.

Here, the average opening diameter of the through-holes is preferably 1 μm to 45 μm, more preferably 1 μm to 40 μm, and still more preferably 1 μm to 30 μm, from the viewpoint of tensile strength, light-transmitting properties, and the like.

In addition, the average opening ratio determined by the through-holes is preferably 2% to 45%, more preferably 2% to 30%, and still more preferably 2% to 20%, from the viewpoint of tensile strength, light-transmitting properties, and the like.

Here, the average opening diameter of the through-holes is obtained in such a manner that the surface of the metal foil is imaged from directly above at a magnification of 100 to 10,000 times using a high-resolution scanning electron microscope (SEM), at least 20 through-holes whose periphery is connected in a ring shape are extracted in the obtained SEM micrograph, diameters of the extracted through-holes are read out to obtain opening diameters, and the average value of the opening diameters is calculated as the average opening diameter.

With regard to the magnification, a magnification in the above-mentioned range can be appropriately selected such that a SEM micrograph from which 20 or more through-holes can be extracted is obtained. In addition, with regard to the opening diameter, a maximum value of a distance between the ends of the through-hole portion is measured. That is, the shape of the opening of the through-hole is not limited to the substantially circular shape, and therefore in a case where the shape of the opening is non-circular, the maximum value of the distance between the ends of the through-hole portion is defined as the opening diameter. Therefore, for example, even in a case of a through-hole having a shape in which two or more through-holes are integrated, this is regarded as one through-hole, and the maximum value of the distance between the ends of the through-hole portion is defined as the opening diameter.

In addition, the average opening ratio determined by the through-holes is obtained in such a manner that a parallel light optical unit is installed on one surface side of the metal foil, parallel light is allowed to transmit therethrough, and the surface of the metal foil is imaged from the other surface of the metal foil with an optical microscope at a magnification of 100 times to obtain a micrograph thereof. For visual fields (5 places) of 100 mm×75 mm in a range of 10 cm×10 cm of the obtained micrograph, a ratio (opening area/geometric area) is calculated from a total opening area of the through-holes projected by the transmitted parallel light and an area of the visual field (geometric area), and then an average value of the calculated ratio in each visual field (5 places) is calculated as the average opening ratio.

The material of the metal foil is not particularly limited. The metal foil is preferably a foil composed of a metal and/or a metal compound capable of easily forming a through-hole, and more preferably a foil composed of a metal. In addition, the metal foil is also preferably a metal foil containing a metal atom that dissolves in an etchant used in a through-hole forming step B which will be described later.

Specific examples of the metal foil include an aluminum foil, a copper foil, a silver foil, a gold foil, a platinum foil, a stainless steel foil, a titanium foil, a tantalum foil, a molybdenum foil, a niobium foil, a zirconium foil, a tungsten foil, a beryllium copper foil, a phosphor bronze foil, a brass foil, a nickel silver foil, a tin foil, a lead foil, a zinc foil, a solder foil, an iron foil, a nickel foil, a Permalloy foil, a nichrome foil, an Alloy 42 foil, a Kovar foil, a Monel foil, an Inconel foil, and a Hastelloy foil.

In addition, the metal foil may be a foil in which two or more different metals including the above-mentioned types of metals are laminated.

The method for laminating the metal foil is not particularly limited, but is preferably by means of a plating or cladding material. The metal used for plating is preferably a metal containing a metal atom that dissolves in an etchant, and is preferably a metal. Examples of plating species include nickel, chromium, cobalt, iron, zinc, tin, copper, silver, gold, platinum, palladium, and aluminum.

The plating method is not particularly limited, and any of electroless plating, electrolytic plating, hot dip plating, and chemical conversion treatment is used.

In addition, the metal used for forming a cladding material on the metal foil is preferably a metal containing a metal atom that dissolves in an etchant, and is preferably a metal. Examples of the metal species include metals used for the metal foil.

From the viewpoint of availability, easy formation of through-holes, and the like, the material of the metal foil preferably includes at least one selected from the group consisting of aluminum, copper, stainless steel, and nickel and more preferably aluminum.

The average thickness of the metal foil is preferably 5 μm to 1,000 μm. From the viewpoint of handleability, the average thickness of the metal foil is more preferably 5 μm to 50 μm and still more preferably 8 μm to 30 μm.

Here, the average thickness of the metal foil refers to an average value of thicknesses measured at any five points using a contact type film thickness meter (digital electronic micrometer).

<Aluminum Foil>

In a case where an aluminum foil is used as the metal foil, the aluminum is not particularly limited, and known aluminum alloys such as 1000 series aluminum alloys, 3000 series aluminum alloys (for example, Aluminum Alloy 3003), 5000 series aluminum alloys, 7000 series aluminum alloys, and 8000 series aluminum alloys (for example, Aluminum Alloy 8021) can be used.

As such aluminum alloys, for example, aluminum alloys with alloy numbers shown in Table 1 given below can be used.

Above all, 1000 series aluminum alloys such as Aluminum Alloys 1N30, 1100, 1050, and 1085, or materials obtained by adding a small amount of Mg, Mn, Zn, or the like to these aluminum alloy materials are preferable because the aluminum alloy materials can be obtained at low cost.

TABLE 1

| | Si | Fe | Cu |
|---|---|---|---|
| Alloy No. | (% by mass) | (% by mass) | (% by mass) |
| 1085 | 0.02 | 0.04 | <0.01 |
| IN30 | 0.11 | 0.45 | 0.02 |
| 8021 | 0.04 | 1.44 | <0.01 |
| 3003 | 0.60 | 0.70 | 0.10 |

[Protective Layer]

The protective layer 7 is a layer provided on at least one surface of the metal foils 3 and for protecting the metal foil 3.

The protective layer 7 contains a metal oxide.

In addition, the light transmittance of the protective layer 7 is 10% or more.

The light transmittance of the protective layer is preferably 50% or more and more preferably 90% or more, from the viewpoint of maintaining metallic luster, light-transmitting properties, and the like.

Here, the light transmittance of the protective layer is a light transmittance in a wavelength range of 200 nm to 900 nm including the visible light range, and may be measured in accordance with JISK 7361 by forming a sample of the protective layer on a transparent support and using a commercially available determination device such as NDH4000 or SH-7000 manufactured by Nippon Denshoku Industries Co., Ltd. In addition, it is also possible to measure the transmittance of the metal foil before the protective layer is formed thereon and the transmittance of the protective layer and the metal foil in a laminated state, and then obtain the transmittance of the protective layer alone from the ratio therebetween.

The average thickness of the protective layer is preferably 0.1 μm to 100 μm, more preferably 0.5 μm to 30 μm, and still more preferably 1 μm to 10 μm, from the viewpoint of maintaining metallic luster, light-transmitting properties, scratch resistance, weather fastness, solvent resistance, and the like.

Here, the average thickness of the protective layer refers to an average value of thicknesses measured at any five points using a contact type film thickness meter (digital electronic micrometer).

The content of the metal oxide in the protective layer is not limited, but is preferably 60% by mass or more, more preferably 80% by mass or more, and still more preferably 90% by mass or more with respect to the total mass of the protective layer, from the viewpoint of scratch resistance, weather fastness, solvent resistance, and the like.

Examples of the metal oxide used for the protective layer include silica (silicon oxide), titanium oxide, boron oxide, aluminum oxide, zirconium oxide, and a composite thereof. The protective layer containing a metal oxide used in the present invention is obtained by applying a so-called sol-gel reaction solution including an organic metal compound or an inorganic metal compound, hydrolysis and polycondensation of which having been carried out in water and an organic solvent in the presence of a catalyst such as an acid or an alkali, onto the surface of a metal foil and then drying the applied reaction solution. Examples of the organic metal compound or the inorganic metal compound used here include a metal alkoxide, a metal acetylacetonate, a metal acetate, a metal oxalate, a metal nitrate, a metal sulfate, a metal carbonate, a metal oxychloride, a metal chloride, and a condensate obtained by partial hydrolysis and oligomerization thereof.

Above all, the metal oxide contained in the protective layer is preferably silica from the viewpoint of light-transmitting properties, scratch resistance, weather fastness, solvent resistance, and the like.

The metal alkoxide is represented by General Formula of M(OR)ₙ where M represents a metal element, R represents an alkyl group, and n represents an oxidation number of the metal element). Examples of the metal alkoxide that can be used include Si(OCH₃)₄, Si(OC₂H₅)₄, Si(OC₃H₇)₄, Si(OC₄H₉)₄, Al(OCH₃)₃, Al(OC₂H₅)₃, Al(OC₃H₇)₃, Al(OC₄H₉)₃, B(OCH₃)₃, B(OC₂H₅)₃, B(OC₃H₇)₃, B(OC₄H₉)₃, Ti(OCH₃)₄, Ti(OC₂H₅)₄, Ti(OC₃H₇)₄, Ti(OC₄H₉)₄, Zr(OCH₃)₄, Zr(OC₂H₅)₄, Zr(OC₃H₇)₄, and Zr(OC₄H₉)₄. Other examples of the metal alkoxide include alkoxides of Ge, Li, Na, Fe, Ga, Mg, P, Sb, Sn, Ta, V, and the like. In addition, mono-substituted silicon alkoxides such as CH₃Si(OCH₃)₃, C₂H₅Si(OCH₃)₃, CH₃Si(OC₂H₅)₃, and C₂H₅Si(OC₂H₅)₃ are also used. Examples of the metal acetylacetonate include Al(COCH₂COCH₃)₃ and Ti(COCH₂COCH₃)₄. Examples of the metal oxalate include K₂TiO(C₂O₄)₂, and examples of the metal nitrate include Al(NO₃)₃ and ZrO(NO₃)₂.2H₂O. Examples of the metal sulfate include Al₂(SO₄)₃, (NH₄)Al(SO₄)₂, KAl(SO₄)₂, and NaAl(SO₄)₂, examples of the metal oxychloride include Si₂OCl₆ and ZrOCl₂, and examples of the chloride include AlCl₃, SiCl₄, ZrCl₂, and TiCl₄.

These organic metal compounds or inorganic metal compounds may be used alone or in combination of two or more thereof. Among these organic metal compounds or inorganic metal compounds, a metal alkoxide is preferable from the viewpoint of being rich in reactivity and easily generating a polymer from a metal-oxygen bond. Among the examples, a silicon alkoxy compound such as Si(OCH₃)₄, Si(OC₂H₅)₄, Si(OC₃H₇)₄, or Si(OC₄H₉)₄ is particularly preferable from the viewpoint of availability at low cost, and excellent solvent resistance of a protective layer containing a metal oxide obtained from the alkoxy compound. In addition, an oligomer obtained by partial hydrolysis and condensation of the silicon alkoxy compound is also preferable. The oligomer may be, for example, an ethyl silicate oligomer of pentamer as an average containing about 40% by weight of SiO₂. Further, a preferred example is also a combination of a metal alkoxide and a so-called silane coupling agent in which one or two alkoxy groups of the above-mentioned silicon tetraalkoxy compound have been substituted by an alkyl group or a reactive group. Examples of the silane coupling agent used in this case include vinyltrimethoxysilane, vinyltriethoxysilane, γ-(methacryloxypropyl)trimethoxysilane, β-(3,4-epoxycyclohexyl)ethyltrimethoxysilane, γ-glycidoxypropyltrimethoxysilane, γ-glycidoxypropylmethyldiethoxysilane, N-β-(aminoethyl) γ-aminopropyltrimethoxysilane, N-β-(aminoethyl) γ-aminopropylmetyldimethoxysilane, γ-aminopropyltriethoxysilane, N-phenyl-γ-aminopropyltrimethoxysilane, γ-mercaptopropyltrimethoxysilane, γ-chloropropyltrimethoxysilane, methyltrimethoxysilane, and methyltriethoxysilane.

On the other hand, organic and inorganic acids and alkalis are used as the catalyst. Examples thereof include inorganic acids such as hydrochloric acid, sulfuric acid, sulfurous acid, nitric acid, nitrous acid, hydrofluoric acid, phosphoric acid, and phosphorous acid; organic acids such as formic acid, acetic acid, propionic acid, butyric acid, glycolic acid, chloroacetic acid, dichloroacetic acid, trichloroacetic acid, fluoroacetic acid, bromoacetic acid, methoxyacetic acid, oxaloacetic acid, citric acid, oxalic acid, succinic acid, malic acid, tartaric acid, fumaric acid, maleic acid, malonic acid, ascorbic acid, benzoic acid, substituted benzoic acid such as 3,4-dimethoxybenzoic acid, phenoxyacetic acid, phthalic acid, picric acid, nicotinic acid, picolinic acid, pyrazine, pyrazol, dipicolinic acid, adipic acid, p-toluic acid, terephthalic acid, 1,4-cyclohexene-2,2-dicarboxylic acid, erucic acid, lauric acid, and n-undecanoic acid; hydroxides of alkali metals and alkaline earth metals; and alkalis such as ammonia, ethanolamine, diethanolamine, and triethanolamine. Other examples of the catalyst that can also be used include sulfonic acids, sulfinic acids, alkylsulfuric acids, phosphonic acids, and phosphates, specific examples of which include organic acids such as p-toluene sulfonic acid, dodecylbenzene sulfonic acid, p-toluene sulfinic acid, ethyl sulfate, phenyl phosphonic acid, phenyl phosphinic acid, phenyl phosphate, and diphenyl phosphate. These catalysts may be used alone or in combination of two or more thereof. The amount of the catalyst is preferably in a range of 0.001% to 10% by weight and more preferably in a range of 0.05% to 5% by weight with respect to the metal compound as a raw material. In a case where the amount of the catalyst is below the above-mentioned range, the initiation of the sol-gel reaction is retarded, and in a case where the amount of the catalyst exceeds the above-mentioned range, the reaction rapidly proceeds to form non-uniform sol-gel particles, which results in inferior solvent resistance of the obtained protective layer.

The initiation of the sol-gel reaction further requires an adequate amount of water. A preferable addition amount of water is preferably 0.05 to 50 fold molar and more preferably 0.5 to 30 fold molar with respect to the amount of water necessary for complete hydrolysis of the metal compound as the raw material. In a case where the amount of water is below the above-mentioned range, hydrolysis proceeds sluggishly. In a case where the amount of water exceeds the above-mentioned range, the reaction proceeds sluggishly too, probably due to the raw material being excessively diluted. A solvent is further added to the sol-gel reaction solution. The solvent may be any one as long as it dissolves the metal compound as the raw material and dissolves or disperses sol-gel particles formed by a reaction, and examples thereof include lower alcohols such as methanol, ethanol, propanol, and butanol, and ketones such as acetone, methyl ethyl ketone, and diethyl ketone. In addition, mono- or di-alkyl ethers and acetates of glycols such as ethylene glycol, diethylene glycol, triethylene glycol, propylene glycol, and dipropylene glycol can be used for the purpose of improving the quality of the coating surface of the protective layer. Among these solvents, lower alcohols which are miscible with water are preferable. The sol-gel reaction solution is prepared with a solvent to have a concentration suitable for coating; however, the hydrolysis reaction proceeds sluggishly probably due to excessive dilution of the raw material in a case where the entire amount of the solvent is added into the reaction solution from the beginning. Therefore, a method of adding a part of the solvent to the sol-gel reaction solution and then adding the remaining solvent after the reaction proceeds is preferable.

The sol-gel reaction proceeds by mixing a metal oxide raw material, water, a solvent and a catalyst. The progress of the reaction depends on the type thereof, the compositional ratio, and the reaction temperature and time, and also affects the film quality after film formation. In particular, since an effect of the reaction temperature is large, it is preferable to control the temperature during the reaction. In addition to the above-mentioned essential components, a compound containing a hydroxyl group, an amino group, or an active hydrogen in a molecule thereof may be added to the sol-gel reaction solution in order to appropriately adjust the sol-gel reaction. Examples of such a compound include polyethylene glycols, polypropylene glycols, block copolymers thereof, and monoalkyl ethers or monoalkylaryl ethers thereof; various types of phenols such as phenol and cresol; polyvinyl alcohols and copolymers thereof with other vinyl monomers; acids having a hydroxyl group such as malic acid and tartaric acid; aliphatic and aromatic amines; and formamides and dimethylformamides. Furthermore, if necessary, an organic or inorganic polymer compound can be added in order to improve film properties of the protective layer, and a plasticizer, a surfactant, and other additives can be added to make the protective layer flexible and to adjust the slipperiness thereof. Preferred examples of the polymer compound include a polyvinyl alcohol, a polyvinyl acetate, a silicone resin, a polyamide, a polyurethane, a polyurea, a polyimide, a polysiloxane, a polycarbonate, an epoxy resin, a phenol novolac resin, a condensed resin of phenol and aldehyde or ketone, an acetal resin, a polyvinyl chloride, a polyvinylidene chloride, a polystyrene, an acrylic resin, and a copolymer resin thereof. Among these polymer compounds, specifically a novolac resin of phenol, cresol, ter-butylphenol, octylphenol, or the like, a condensed resin of pyrogallol and acetone, a homopolymer or copolymer of p-hydroxystyrene or hydroxyethyl methacrylate, and the like are preferably used.

Preferred examples of the plasticizer, which is added to the protective layer and is effective, include phthalates such as dimethyl phthalate, diethyl phthalate, dibutyl phthalate, diisobutyl phthalate, dioctyl phthalate, octyl capryl phthalate, dicyclohexyl phthalate, ditridecyl phthalate, butyl benzyl phthalate, diisodecyl phthalate, and diallyl phthalate; glycol esters such as dimethyl glycol phthalate, ethyl phthalyl ethyl glycolate, methyl phthalyl ethyl glycolate, butyl phthalyl butyl glycolate, and triethylene glycol dicaprylate; phosphates such as tricresyl phosphate and triphenyl phosphate; aliphatic dicarboxylic acid esters such as diisobutyl adipate, dioctyl adipate, dimethyl sebacate, dibutyl sebacate, dioctyl azelate, and dibutyl maleate; polyglycidyl methacrylate; triethyl citrate; glycerin triacetyl ester; and butyl laurate. The plasticizer is added to an extent that the protective layer is not sticky.

Preferred examples of the surfactant, which is added to the protective layer, include nonionic surfactants such as polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylene hydrogenated castor oils, polyoxyethylene glycerin fatty acid partial esters, fatty acid diethanolamides, N,N-bis-2-hydroxyalkylamines, polyoxyethylene alkylamines, triethanolamine fatty acid esters, and trialkylamine oxides; anionic surfactants such as fatty acid salts, avietates, hydroxyalkane sulfonates, alkane sulfonates, dialkyl sulfosuccinates, linear alkylbenzene sulfonates, branched alkylbenzene sulfonates, alkylnaphthalene sulfonates, alkylphenoxypolyoxyethylene propyl sulfonates,

polyoxyethylene alkyl sulfophenyl ether salts, N-methyl-N-oleyl taurine sodium salts, N-alkyl sulfosuccinic acid monoamide disodium salts, petroleum sulfonates, sulfated beef tallow oils, sulfate ester salts of fatty acid alkyl esters, alkyl sulfate ester salts, polyoxyethylene alkyl ether sulfate ester salts, fatty acid monoglyceride sulfate ester salts, polyoxyethylene alkylphenyl ether sulfate ester salts, polyoxyethylene styrylphenyl ether sulfate ester salts, alkyl phosphate ester salts, polyoxyethylene alkyl ether phosphate ester salts, polyoxyethylene alkylphenyl ether phosphate ester salts, partial saponification products of styrene/maleic acid anhydride copolymers, partial saponification products of olefin/maleic acid anhydride copolymers, and naphthalene sulfonate formalin condensates; cationic surfactants such as alkylamine salts, quaternary ammonium salts, polyoxyethylene alkylamine salts, and polyethylene polyamine derivatives; and amphoteric surfactants such as carboxybetaines, aminocarboxylic acids, sulfobetaines, amino sulfate esters, and imidazolines. The term “polyoxyethylene” as described above as to the surfactants can also be read as polyoxyalkylene such as polyoxymethylene, polyoxypropylene, or polyoxybutylene, and surfactants thereof are also included in the scope of the present invention.

A further preferred surfactant is a fluorine-based surfactant containing a perfluoroalkyl group in the molecule thereof. Examples of such a fluorine-based surfactant include anionic surfactants such as perfluoroalkyl carboxylates, perfluoroalkyl sulfonates, and perfluoroalkyl phosphates; amphoteric surfactants such as perfluoroalkyl betaines; cationic surfactants such as perfluoroalkyl trimethylammonium salts; and nonionic surfactants such as perfluoroalkylamine oxides, perfluoroalkyl ethylene oxide adducts, oligomers each having a perfluoroalkyl group and a hydrophilic group, oligomers each having a perfluoroalkyl group and a lipophilic group, oligomers each having a perfluoroalkyl group, a hydrophilic group, and a lipophilic group, and urethanes each having a perfluoroalkyl group and a lipophilic group. The above-mentioned surfactants may be used alone or in combination of two or more thereof, and are added to the protective layer in a range of 0.001% to 10% by weight and more preferably 0.01% to 5% by weight.

[Resin Layer]

The resin layer that the laminate according to the embodiment of the present invention may have is not particularly limited as long as it is a layer formed of a resin material having transparency, and examples of the resin material include polyester and polyolefin.

Specific examples of the polyester include polyethylene terephthalate (PET) and polyethylene naphthalate.

Specific examples of other resin materials include polyamide, polyether, polystyrene, polyester amide, polycarbonate, polyphenylene sulfide, polyether ester, polyvinyl chloride, polyacrylate, and polymethacrylate.

Here, the phrase “the resin layer has transparency” means that the transmittance of visible light is 60% or more, preferably 80% or more, and particularly preferably 90% or more.

The average thickness of the resin layer is preferably 12 to 200 more preferably 12 to 100 still more preferably 25 to 100 μm, and particularly preferably 50 to 100 μm, from the viewpoint of handleability, workability, and the like.

Here, the average thickness of the resin layer refers to an average value of thicknesses measured at any five points using a contact type film thickness meter (digital electronic micrometer).

[Method for Producing Laminate]

The laminate according to the embodiment of the present invention can be produced by producing a metal foil having a plurality of through-holes and providing a protective layer on the surface of the metal foil.

<<Method for Forming Protective Layer>>

As described hereinbefore, the method for forming a protective layer may be, for example, a method of applying a so-called sol-gel reaction solution including an organic metal compound or an inorganic metal compound, hydrolysis and polycondensation of which having been carried out in water and an organic solvent in the presence of a catalyst such as an acid or an alkali, onto the surface of a metal foil having through-holes and then drying the applied reaction solution.

<<Method for Producing Metal Foil Having Through-Holes>>

Next, the method for producing a metal foil having through-holes will be described.

In a case where an aluminum foil is used as the metal foil, the method for producing a metal foil having through-holes may be, for example, a method including a film forming step of forming an aluminum hydroxide film on at least one surface of the aluminum foil, a through-hole forming step A of carrying out a through-hole forming treatment to form a through-hole, after the film forming step, and a film removing step of removing the aluminum hydroxide film, after the through-hole forming step A (hereinafter, also referred to as “production method A-1”); or a method including a resin layer forming step of forming a resin layer on one surface of the aluminum foil, a film forming step of forming an aluminum hydroxide film on the surface of the aluminum foil on the side where the resin layer is not provided, after the resin layer forming step, a through-hole forming step A of carrying out a through-hole forming treatment to form a through-hole, after the film forming step, and a film removing step of removing the aluminum hydroxide film, after the through-hole forming step A (hereinafter, also referred to as “production method A-2”). Of these methods, the production method A-1 is preferable.

In a case where a metal other than aluminum is used as the material of the metal foil, the method for producing a metal foil having through-holes may be, for example, a production method including a first masking layer forming step of forming a first masking layer containing particles on at least one surface of the metal foil, a through-hole forming step B of forming a through-hole in the metal foil, and a masking layer removing step of removing the first masking layer, after the through-hole forming step B (hereinafter, also referred to as “production method B”). The production method B can also be applied in a case where aluminum is used as the material of the metal foil.

Hereinafter, individual steps of the methods A-1 and A-2 for producing a metal foil having through-holes in a case where an aluminum foil is used as the metal foil will be described with reference to FIG. 5 to FIG. 8, FIG. 9 to FIG. 12, and FIG. 13 to FIG. 17, and then each step will be described in detail.

FIG. 5 to FIG. 8 and FIG. 9 to FIG. 12 are respectively schematic cross-sectional views showing an example of a suitable embodiment of the method A-1 for producing a metal foil (aluminum foil) having through-holes.

As shown in FIG. 5 to FIG. 8 and FIG. 9 to FIG. 12, the production method A-1 is a production method including a film forming step (FIG. 5 and FIG. 6, FIG. 9 and FIG. 10) of carrying out a film forming treatment to form an aluminum hydroxide film 2 on one surface (both surfaces in the aspect shown in FIG. 9) of a metal foil (aluminum foil) 1, a through-hole forming step A (FIG. 6 and FIG. 7, FIG. 10 and FIG. 11) of carrying out an electrolytic dissolution treatment to form through-holes 5 to produce a composite having a metal foil 3 having through-holes (aluminum foil having through-holes) and an aluminum hydroxide film 4 having through-holes, after the film forming step, and a film removing step (FIG. 7 and FIG. 8, FIG. 11 and FIG. 12) of removing the aluminum hydroxide film 4 having through-holes to produce an aluminum foil 3 having through-holes, after the through-hole forming step A.

FIG. 13 to FIG. 17 are schematic cross-sectional views showing an example of a suitable embodiment of the method B for producing a metal foil having through-holes.

As shown in FIG. 13 to FIG. 17, the production method A-2 is a production method including a resin layer forming step (FIG. 13 and FIG. 14) of forming a resin layer 6 on one surface of an aluminum foil 1, a film forming step (FIG. 14 and FIG. 15) of carrying out a film forming treatment on the surface of the aluminum foil 1 on the side where the resin layer 6 is not formed to form an aluminum hydroxide film 2, a through-hole forming step A (FIG. 15 and FIG. 16) of carrying out an electrolytic dissolution treatment to form through-holes 5 to produce a composite having an aluminum foil 3 having through-holes, an aluminum hydroxide film 4 having through-holes and a resin layer 6 having no through-holes, after the film forming step, and a film removing step (FIG. 16 and FIG. 17) of removing the aluminum hydroxide film 4 having through-holes to produce a composite having the aluminum foil 3 having through-holes and the resin layer 6 having no through-holes, after the through-hole forming step A.

[Film Forming Step]

The film forming step is a step of carrying out a film forming treatment on a surface of an aluminum foil to form an aluminum hydroxide film.

<Film Forming Treatment>

The film forming treatment is not particularly limited, and for example, the same treatment as the conventionally known film forming treatment can be carried out.

For example, the conditions and devices described in paragraphs [0013] to [0026] of JP2011-201123A can be appropriately adopted for the film forming treatment.

In the present invention, the conditions for the film forming treatment vary depending on the electrolytic solution used and thus cannot be unconditionally determined; but in general, the conditions for the film forming treatment are suitably an electrolytic solution concentration of 1% to 80% by mass, a liquid temperature of 5° C. to 70° C., a current density of 0.5 to 60 A/dm², a voltage of 1 to 100 V, and an electrolysis time of 1 second to 20 minutes, which are adjusted so as to obtain a desired film amount.

In the present invention, it is preferable to carry out an electrochemical treatment using nitric acid, hydrochloric acid, sulfuric acid, phosphoric acid, oxalic acid, or a mixed acid of two or more of these acids as the electrolytic solution.

In a case where the electrochemical treatment is carried out in an electrolytic solution containing nitric acid or hydrochloric acid, a direct current may be applied between an aluminum foil and a counter electrode, or an alternating current may be applied therebetween. In a case where a direct current is applied to the aluminum foil, the current density is preferably 1 to 60 A/dm² and more preferably 5 to 50 A/dm². In a case where the electrochemical treatment is continuously carried out, it is preferably carried out by a liquid power supply method in which power is supplied to the aluminum foil through an electrolytic solution.

In the present invention, the amount of the aluminum hydroxide film formed by the film forming treatment is preferably 0.05 to 50 g/m² and more preferably 0.1 to 10 g/m².

[Through-Hole Forming Step A]

The through-hole forming step A is a step of forming a through-hole by carrying out an electrolytic dissolution treatment after the film forming step.

<Electrolytic Dissolution Treatment>

The electrolytic dissolution treatment is not particularly limited and is carried out using a direct current or an alternating current. An acidic solution can be used for the electrolytic solution. Above all, it is preferable to carry out the electrochemical treatment using at least one acid of nitric acid or hydrochloric acid, and it is more preferable to carry out the electrochemical treatment using a mixed acid obtained by adding at least one or more acids of sulfuric acid, phosphoric acid, and oxalic acid to these acids.

In the present invention, in addition to the above-mentioned acids, the electrolytic solutions described in each specification of U.S. Pat. Nos. 4,671,859A, 4,661,219A, 4,618,405A, 4,600,482A, 4,566,960A, 4,566,958A, 4,566,959A, 4,416,972A, 4,374,710A, 4,336,113A, 4,184,932A, and the like can also be used as the acidic solution which is an electrolytic solution.

The concentration of the acidic solution is preferably 0.1% to 2.5% by mass and particularly preferably 0.2% to 2.0% by mass. In addition, the liquid temperature of the acidic solution is preferably 20° C. to 80° C. and more preferably 30° C. to 60° C.

In addition, an aqueous solution containing the foregoing acid as a main component can be used by adding at least one of a nitric acid compound having a nitrate ion (such as aluminum nitrate, sodium nitrate, or ammonium nitrate), a hydrochloric acid compound having a chloride ion (such as aluminum chloride, sodium chloride, or ammonium chloride), or a sulfuric acid compound having a sulfate ion (such as aluminum sulfate, sodium sulfate, or ammonium sulfate) in a range of from 1 g/L to saturation to the aqueous solution of an acid having a concentration of 1 to 100 g/L.

Here, the phrase “containing . . . as a main component” means that the main component in the aqueous solution is contained in an amount of 30% by mass or more and preferably 50% by mass or more with respect to the total components added to the aqueous solution. Hereinafter, the same applies to other components.

In addition, a metal contained in an aluminum alloy, such as iron, copper, manganese, nickel, titanium, magnesium, or silica, may be dissolved in the aqueous solution containing the foregoing acid as a main component. It is preferable to use a liquid in which aluminum chloride, aluminum nitrate, aluminum sulfate, or the like is added to an aqueous solution having an acid concentration of 0.1% to 2% by mass such that aluminum ions are 1 to 100 g/L.

A direct current is mainly used in the electrochemical dissolution treatment, but in a case where an alternating current is used, the alternating current power wave is not particularly limited, and a sine wave, a rectangular wave, a trapezoidal wave, a triangular wave, or the like is used. Among these, a rectangular wave or a trapezoidal wave is preferable, and a trapezoidal wave is particularly preferable.

(Nitric Acid Electrolysis)

In the present invention, through-holes having an average opening diameter of 0.1 μm or more and less than 100 μm can be easily formed by an electrochemical dissolution treatment using an electrolytic solution containing nitric acid as a main component (hereinafter, also referred to simply as “nitric acid dissolution treatment”).

Here, the nitric acid dissolution treatment is preferably an electrolytic treatment carried out using a direct current under conditions that the average current density is 5 A/dm² or more and the electric quantity is 50 C/dm² or more because it is easy to control the dissolution point of through-hole formation. The average current density is preferably 100 A/dm² or less, and the electric quantity is preferably 10,000 C/dm² or less.

In addition, the concentration and temperature of the electrolytic solution in nitric acid electrolysis are not particularly limited. The electrolysis can be carried out at 30° C. to 60° C. using a nitric acid electrolytic solution having a high concentration, for example, a nitric acid concentration of 15% to 35% by mass, or the electrolysis can be carried out at a high temperature, for example, 80° C. or higher using a nitric acid electrolytic solution having a nitric acid concentration of 0.7% to 2% by mass.

In addition, the electrolysis can be carried out using an electrolytic solution obtained by mixing at least one of sulfuric acid, oxalic acid, or phosphoric acid having a concentration of 0.1% to 50% by mass with the nitric acid electrolytic solution.

(Hydrochloric Acid Electrolysis)

In the present invention, through-holes having an average opening diameter of 1 μm or more and less than 100 μm can also be easily formed by an electrochemical dissolution treatment using an electrolytic solution containing hydrochloric acid as a main component (hereinafter, also referred to simply as “hydrochloric acid dissolution treatment”).

Here, the hydrochloric acid dissolution treatment is preferably an electrolytic treatment carried out using a direct current under the conditions that the average current density is 5 A/dm² or more and the electric quantity is 50 C/dm² or more because it is easy to control the dissolution point of through-hole formation. The average current density is preferably 100 A/dm² or less, and the electric quantity is preferably 10,000 C/dm² or less.

In addition, the concentration and temperature of the electrolytic solution in hydrochloric acid electrolysis are not particularly limited. The electrolysis can be carried out at 30° C. to 60° C. using a hydrochloric acid electrolytic solution having a high concentration, for example, a hydrochloric acid concentration of 10% to 35% by mass, or the electrolysis can be carried out at a high temperature, for example, 80° C. or higher using a hydrochloric acid electrolytic solution having a hydrochloric acid concentration of 0.7% to 2% by mass.

In addition, the electrolysis can be carried out using an electrolytic solution obtained by mixing at least one of sulfuric acid, oxalic acid, or phosphoric acid having a concentration of 0.1% to 50% by mass with the hydrochloric acid electrolytic solution.

[Film Removing Step]

The film removing step is a step of carrying out a chemical dissolution treatment to remove the aluminum hydroxide film.

The film removing step is capable of removing the film by carrying out, for example, an acid etching treatment or alkaline etching treatment which will be described later.

In a case where the film is removed by the alkaline etching treatment, it is desirable to wash with an acidic solution in order to remove the corrosive organisms remaining on the surface after the alkaline etching treatment. By selecting the washing conditions with an acidic solution, it is possible to additionally have a film removing function.

<Acid Etching Treatment>

The acid etching treatment is a treatment for dissolving the aluminum hydroxide film using a solution that preferentially dissolves aluminum hydroxide over aluminum (hereinafter, referred to as “aluminum hydroxide-dissolving solution”).

Here, the aluminum hydroxide-dissolving solution is preferably, for example, an aqueous solution containing at least one selected from the group consisting of nitric acid, hydrochloric acid, sulfuric acid, phosphoric acid, oxalic acid, a chromium compound, a zirconium-based compound, a titanium-based compound, a lithium salt, a cerium salt, a magnesium salt, sodium silicofluoride, zinc fluoride, a manganese compound, a molybdenum compound, a magnesium compound, a barium compound, and elemental halogen.

Specifically, examples of the chromium compound include chromium (III) oxide and chromium (VI) anhydride.

Examples of the zirconium-based compound include zirconium ammonium fluoride, zirconium fluoride, and zirconium chloride.

Examples of the titanium compound include titanium oxide and titanium sulfide.

Examples of the lithium salt include lithium fluoride and lithium chloride.

Examples of the cerium salt include cerium fluoride and cerium chloride.

Examples of the magnesium salt include magnesium sulfide.

Examples of the manganese compound include sodium permanganate and calcium permanganate.

Examples of the molybdenum compound include sodium molybdate.

Examples of the magnesium compound include magnesium fluoride pentahydrate.

Examples of the barium compound include barium oxide, barium acetate, barium carbonate, barium chlorate, barium chloride, barium fluoride, barium iodide, barium lactate, barium oxalate, barium perchlorate, barium selenate, barium selenite, barium stearate, barium sulfite, barium titanate, barium hydroxide, barium nitrate, and hydrates thereof.

Among the foregoing barium compounds, barium oxide, barium acetate, and barium carbonate are preferable, and barium oxide is particularly preferable.

Examples of the elemental halogen include chlorine, fluorine, and bromine.

Above all, the aluminum hydroxide-dissolving solution is preferably an aqueous solution containing an acid. Examples of the acid include nitric acid, hydrochloric acid, sulfuric acid, phosphoric acid, and oxalic acid. The acid may be a mixture of two or more acids. Above all, it is preferable to use nitric acid as the acid.

The acid concentration is preferably 0.01 mol/L or more, more preferably 0.05 mol/L or more, and still more preferably 0.1 mol/L or more. The upper limit of the acid concentration is not particularly limited, but generally it is preferably 10 mol/L or less and more preferably 5 mol/L or less.

The dissolution treatment is carried out by bringing the aluminum foil on which the aluminum hydroxide film is formed into contact with the above-mentioned dissolution solution. The method of bringing the aluminum foil into contact with the dissolution solution is not particularly limited, and examples thereof include a dipping method and a spraying method. Above all, the dipping method is preferable.

The dipping method is a treatment in which an aluminum foil on which an aluminum hydroxide film is formed is dipped in the above-mentioned dissolution solution. It is preferable to carry out the stirring at the time of the dipping treatment, since the treatment without unevenness is carried out.

The dipping treatment time is preferably 10 minutes or more, more preferably 1 hour or more, still more preferably 3 hours or more, and even still more preferably 5 hours or more.

<Alkaline Etching Treatment>

The alkaline etching treatment is a treatment in which a surface layer is dissolved by bringing the aluminum hydroxide film into contact with an alkaline solution.

Examples of the alkali used in the alkaline solution include a caustic alkali and an alkali metal salt. Specifically, examples of the caustic alkali include sodium hydroxide (caustic soda) and caustic potash. In addition, examples of the alkali metal salt include alkali metal silicates such as sodium metasilicate, sodium silicate, potassium metasilicate, and potassium silicate; alkali metal carbonates such as sodium carbonate and potassium carbonate; alkali metal aluminates such as sodium aluminate and potassium aluminate; alkali metal aldonates such as sodium gluconate and potassium gluconate; and alkali metal hydrogen phosphates such as secondary sodium phosphate, secondary potassium phosphate, tertiary sodium phosphate, and tertiary potassium phosphate. Above all, a solution of a caustic alkali and a solution containing both a caustic alkali and an alkali metal aluminate are preferable from the viewpoint of high etching rate and low cost. In particular, an aqueous solution of sodium hydroxide is preferable.

The concentration of the alkaline solution is preferably 0.1% to 50% by mass and more preferably 0.2% to 10% by mass. In a case where aluminum ions are dissolved in the alkaline solution, the concentration of aluminum ions is preferably 0.01% to 10% by mass and more preferably 0.1% to 3% by mass. The temperature of the alkaline solution is preferably 10° C. to 90° C. The treatment time is preferably 1 to 120 seconds.

Examples of the method for bringing the aluminum hydroxide film into contact with the alkaline solution include a method in which an aluminum foil on which an aluminum hydroxide film is formed is passed through a tank containing an alkaline solution; a method in which an aluminum foil on which an aluminum hydroxide film is formed is dipped in a tank containing an alkaline solution; and a method in which an alkaline solution is sprayed onto a surface (aluminum hydroxide film) of an aluminum foil on which the aluminum hydroxide film is formed.

[Resin Layer Forming Step]

The resin layer forming step is a step of forming a resin layer on the surface of a metal foil (aluminum foil) having no through-holes in the production method A-2. In addition, the resin layer forming step is a step of forming a resin layer on the surface of a metal foil as a suitable aspect, after forming a metal foil (aluminum foil) having through-holes by the production method A-1 or a production method B which will be described later.

The method for forming the resin layer is not particularly limited, and examples thereof include dry lamination, wet lamination, extrusion lamination, and inflation lamination.

Above all, as described above, a suitable aspect is an aspect in which the average thickness of the resin layer is 12 to 200 μm (particularly 25 to 100 μm) and an aspect in which the average thickness of the metal foil is 5 to 1,000 and thus a method of forming the resin layer by dry lamination is preferable.

With respect to the dry lamination, for example, the conditions and devices described in paragraphs [0067] to [0078] of JP2013-121673A can be appropriately adopted.

Hereinafter, individual steps of the method B for producing a metal foil in a case where a metal foil other than the aluminum foil is used will be described with reference to FIG. 18 to FIG. 21, and then each step will be described in detail.

FIG. 18 to FIG. 21 are schematic cross-sectional views showing an example of a suitable embodiment of the method B for producing a metal foil having through-holes (hereinafter, also referred to as “production method B-1”).

In the production method B-1, as shown in FIG. 18, a first masking layer 8 in which a part of each of a plurality of metal particles 9 is embedded is formed on one surface of the metal foil 1 by a first masking layer forming step using a composition containing a plurality of metal particles and a polymer component.

In addition, in the production method B-1, as shown in FIG. 19, it is preferable to form a second masking layer 11 on the surface of the metal foil 1 opposite to the surface on which the first masking layer 8 is formed, by an optional second masking layer forming step using the composition containing a polymer component.

In addition, in the production method B-1, as shown in FIG. 20, the through-holes 5 are formed in the first masking layer 8 and the metal foil 1, by a through-hole forming step B in which the metal foil 1 having the first masking layer 8 is brought into contact with an etchant to dissolve a part of metal particles 9 and metal foil 1.

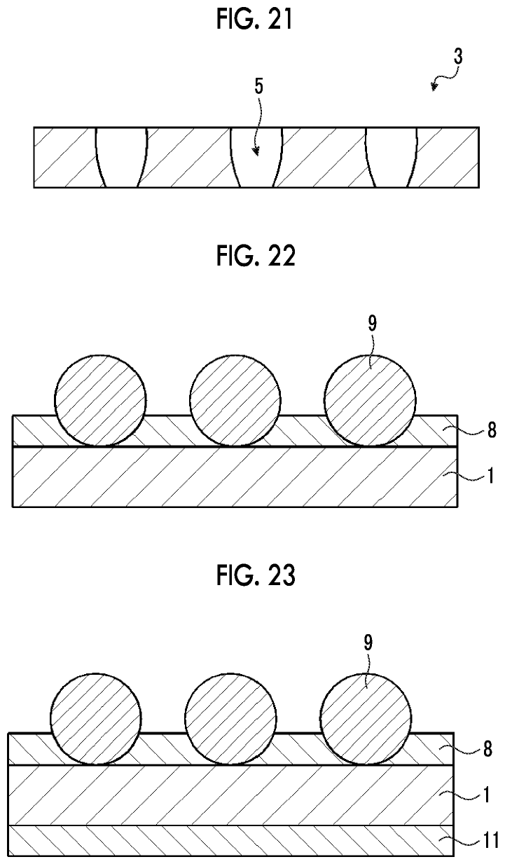

In addition, in the production method B-1, as shown in FIG. 21, a metal foil 3 having a plurality of through-holes 5 is formed by a masking layer removing step of removing the first masking layer 8. In a case where the second masking layer forming step is provided, as shown in FIG. 21, the metal foil 3 having a plurality of through-holes 5 is formed by removing the first masking layer 8 and the second masking layer 11 through the masking layer removing step.

[First Masking Layer Forming Step]

The first masking layer forming step of the production method B-1 is a step of forming a first masking layer in which a part of each of metal particles is embedded on one surface of a metal foil, using a composition containing a plurality of metal particles and a polymer component.

<Composition>

The composition used in the first masking layer forming step is a composition containing at least a plurality of metal particles and a polymer component.

(Metal Particle)

The metal particle contained in the composition is not particularly limited as long as it is a particle containing a metal atom that dissolves in an etchant for use in the through-hole forming step B which will be described later. The metal particle is preferably a particle composed of a metal and/or a metal compound and more preferably a particle composed of a metal.

Specific examples of the metal constituting the metal particle include aluminum, nickel, iron, copper, stainless steel, titanium, tantalum, molybdenum, niobium, zirconium, tungsten, beryllium, and an alloy thereof. These metals may be used alone or in combination of two or more thereof.

Of these metals, aluminum, nickel, and copper are preferable, and aluminum and copper are more preferable.

Examples of the metal compound constituting the metal particle include an oxide, a composite oxide, a hydroxide, a carbonate, a sulfate, a silicate, a phosphate, a nitride, a carbide, a sulfide, and a composite of at least two or more thereof. Specific examples of the metal compound constituting the metal particle include copper oxide, aluminum oxide, aluminum nitride, and aluminum borate.

In the production method B-1, it is preferable that the metal particle and the above-mentioned metal foil contain the same metal atom from the viewpoint of recovering the etchant used in the through-hole forming step which will be described later and recycling the dissolved metal.

The shape of the metal particle is not particularly limited, but is preferably spherical and more preferably closer to a true sphere.

In addition, the average particle size of the metal particles is preferably 1 μm to 10 μm and more preferably more than 2 μm and 6 μm or less, from the viewpoint of dispersibility in the composition.

Here, the average particle size of the metal particles refers to a cumulative 50% size of the particle size distribution measured by a laser diffraction/scattering type particle size analyzer (MICROTRACK MT3000, manufactured by Nikkiso Co., Ltd.).

In addition, the content of the metal particles is preferably 0.05% to 95% by mass, more preferably 1% to 50% by mass, and still more preferably 3% to 25% by mass with respect to the total solid content contained in the composition.

(Polymer Component)

The polymer component contained in the composition is not particularly limited, and a conventionally known polymer component can be used.

Specific examples of the polymer component include an epoxy-based resin, a silicone-based resin, an acrylic resin, a urethane-based resin, an ester-based resin, a urethane acrylate-based resin, a silicone acrylate-based resin, an epoxy acrylate-based resin, an ester acrylate-based resin, a polyamide-based resin, a polyimide-based resin, a polycarbonate-based resin, and a phenol-based resin. These resin materials may be used alone or in combination of two or more thereof.

Above all, the polymer component is preferably a resin material selected from the group consisting of a phenol-based resin, an acrylic resin, and a polyimide-based resin, from the viewpoint that excellent acid resistance is secured and even in a case where an acidic solution is used as the etchant for use in the through-hole forming step B which will be described later, a desired through-hole is easily obtained.

In the present invention, from the viewpoint of easy removal in the masking layer removing step which will be described later, the polymer component contained in the composition is preferably a water-insoluble and alkaline water-soluble polymer (hereinafter, also referred to simply as “alkaline water-soluble polymer”), that is, a homopolymer containing an acidic group in a main chain or side chain of the polymer, a copolymer thereof, or a mixture thereof.

The alkaline water-soluble polymer is preferably a polymer having an acidic group in the main chain and/or side chain of the polymer, from the viewpoint of easier removal in the masking layer removing step which will be described later.

Specific examples of the acidic group include a phenol group (—Ar—OH), a sulfonamide group (—SO₂NH—R), a substituted sulfonamide-based acid group (hereinafter, referred to as “active imide group”) [—SO₂NHCOR, —SO₂NHSO₂R, or —CONHSO₂R], a carboxyl group (—CO₂H), a sulfo group (—SO₃H), and a phosphone group (—OPO₃H₂).

In addition, Ar represents a divalent aryl linking group which may have a substituent, and R represents a hydrocarbon group which may have a substituent.

Among the alkaline water-soluble polymers having an acidic group, an alkaline water-soluble polymer having a phenol group, a carboxyl group, a sulfonamide group, or an active imide group is preferable, and in particular, an alkaline water-soluble polymer having a phenol group or a carboxyl group is most preferable from the viewpoint of the balance between the strength of the first masking layer to be formed and the removability thereof in the masking layer removing step which will be described later.

Examples of the alkaline water-soluble polymer having an acidic group include the following.

Examples of the alkaline water-soluble polymer having a phenol group include a novolac resin produced from one or two or more of phenols such as phenol, o-cresol, m-cresol, p-cresol, and xylenol and aldehydes such as formaldehyde and paraformaldehyde, and a polycondensate of pyrogallol and acetone. Further, a copolymer obtained by copolymerizing a compound having a phenol group can also be mentioned as the alkaline water-soluble polymer. Examples of the compound having a phenol group include acrylamide, methacrylamide, acrylate, methacrylate, and hydroxystyrene, each of which has a phenol group.

Specific examples of the compound having a phenol group include N-(2-hydroxyphenyl)acrylamide, N-(3-hydroxyphenyl)acrylamide, N-(4-hydroxyphenyl)acrylamide, N-(2-hydroxyphenyl)methacrylamide, N-(3-hydroxyphenyl)methacrylamide, N-(4-hydroxyphenyl)methacrylamide, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, o-hydroxystyrene, m-hydroxystyrene, p-hydroxystyrene, 2-(2-hydroxyphenyl)ethyl acrylate, 2-(3-hydroxyphenyl)ethyl acrylate, 2-(4-hydroxyphenyl)ethyl acrylate, 2-(2-hydroxyphenyl)ethyl methacrylate, 2-(3-hydroxyphenyl)ethyl methacrylate, and 2-(4-hydroxyphenyl)ethyl methacrylate.

Among these, a novolac resin or a copolymer of hydroxystyrene is preferable. Examples of commercially available hydroxystyrene copolymers include MARUKA LYNCUR MH-2, MARUKA LYNCUR MS-4, MARUKA LYNCUR MS-2, and MARUKA LYNCUR MS-1 (all manufactured by Maruzen Petrochemical Co., Ltd.), and VP-8000 and VP-15000 (both manufactured by Nippon Soda Co., Ltd.).

The alkaline water-soluble polymer having a sulfonamide group may be, for example, a polymer composed of a minimum constitutional unit derived from a compound having a sulfonamide group, as a main structural component. Examples of the compound having a sulfonamide group as described above include a compound having one or more sulfonamide groups in which at least one hydrogen atom is bonded to a nitrogen atom and one or more polymerizable unsaturated groups in a molecule thereof. Above all, a low molecular weight compound having an acryloyl group, an allyl group, or a vinyloxy group, and a substituted or monosubstituted aminosulfonyl group or a substituted sulfonylimino group in a molecule thereof is preferable.

In particular, m-aminosulfonylphenyl methacrylate, N-(p-aminosulfonylphenyl)methacrylamide, and/or N-(p-aminosulfonylphenyl)acrylamide can be suitably used.

The alkaline water-soluble polymer having an active imide group may be, for example, a polymer composed of a minimum constitutional unit derived from a compound having an active imide group, as a main structural component. Examples of the compound having an active imide group as described above include a compound having one or more active imide groups represented by the following structural formula and one or more polymerizable unsaturated groups in a molecule thereof

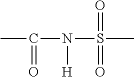

Specifically, N-(p-toluenesulfonyl)methacrylamide and N-(p-toluenesulfonyl)acrylamide can be suitably used.

The alkaline water-soluble polymer having a carboxyl group may be, for example, a polymer having a minimum constitutional unit derived from a compound having one or more carboxyl groups and one or more polymerizable unsaturated groups in a molecule thereof, as a main structural component. Specific examples of the alkaline water-soluble polymer having a carboxyl group include polymers using unsaturated carboxylic compounds such as acrylic acid, methacrylic acid, maleic acid anhydride, and itaconic acid.

The alkaline water-soluble polymer having a sulfo group may be, for example, a polymer having a minimum constitutional unit derived from a compound having one or more sulfo groups and one or more polymerizable unsaturated groups in a molecule thereof, as a main constitutional unit.

The alkaline water-soluble polymer having a phosphone group may be, for example, a polymer having a minimum constitutional unit derived from a compound having one or more phosphone groups and one or more polymerizable unsaturated groups in a molecule thereof, as a main structural component.

The minimum constitutional unit having an acidic group, which constitutes the alkaline water-soluble polymer, is not particularly required to be only one type and alkaline water-soluble polymers obtained by copolymerizing two or more minimum constitutional units having the same acidic group or two or more minimum constitutional units having different acidic groups can also be used.

A conventionally known graft copolymerization method, block copolymerization method, and/or random copolymerization method can be used as the copolymerization method.

The copolymer contains a compound having an acidic group to be copolymerized in an amount of preferably 10 mol % or more and more preferably 20 mol % or more in the copolymer.

In the present invention, in a case where a compound is copolymerized to form a copolymer, another compound containing no acidic group can be used as the compound. Examples of the another compound containing no acidic group include the compounds listed in (m1) to (m11) below.

(m1) acrylates and methacrylates having an aliphatic hydroxyl group such as 2-hydroxyethyl acrylate and 2-hydroxyethyl methacrylate.

(m2) alkyl acrylates such as methyl acrylate, ethyl acrylate, propyl acrylate, butyl acrylate, amyl acrylate, hexyl acrylate, octyl acrylate, benzyl acrylate, 2-chloroethyl acrylate, glycidyl acrylate, and N-dimethylaminoethyl acrylate.

(m3) alkyl methacrylates such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, glycidyl methacrylate, and N-dimethylaminoethyl methacrylate.

(m4) acrylamides and methacrylamides such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacrylamide.

(m5) vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(m6) vinyl esters such as vinyl acetate, vinyl chloroacetate, vinyl butyrate, and vinyl benzoate.

(m7) styrenes such as styrene, α-methylstyrene, methylstyrene, and chloromethyl styrene.

(m8) vinyl ketones such as methyl vinyl ketone, ethyl vinyl ketone, propyl vinyl ketone, and phenyl vinyl ketone.

(m9) olefins such as ethylene, propylene, isobutylene, butadiene, and isoprene.

(m10) N-vinylpyrrolidone, N-vinylcarbazole, 4-vinylpyridine, acrylonitrile, and methacrylonitrile.

(m11) unsaturated imides such as maleimide N-acryloylacrylamide, N-acetylmethacrylamide, N-propionylmethacrylamide, and N-(p-chlorobenzoyl)methacrylamide.

The polymer component, which is regardless of a homopolymer or a copolymer, preferably has a weight-average molecular weight in a range of 1.0×10³ to 2.0×10⁵ and a number-average molecular weight in a range of 5.0×10² to 1.0×10⁵. In addition, the polymer component preferably has a polydispersity (weight-average molecular weight/number-average molecular weight) of 1.1 to 10.

In a case where a copolymer is used as the polymer component, a formulation weight ratio of a minimum constitutional unit that constitutes the main chain and/or side chain thereof and is derived from a compound having an acidic group to the other minimum constitutional unit that constitutes a part of the main chain and/or the side chain and contains no acidic group is preferably in a range of 50:50 to 5:95 and more preferably in a range of 40:60 to 10:90.

The polymer components may each be used alone or in combination of two or more thereof, and are preferably used in a range of 30% to 99% by mass, more preferably in a range of 40% to 95% by mass, and particularly preferably in a range of 50% to 90% by mass with respect to the total solid content contained in the composition.

In the production method B-1, regarding the metal particles and the polymer component described above, it is preferable that the specific gravity of the metal particles is larger than the specific gravity of the polymer component, from the viewpoint that the formation of a through-hole becomes easy in the through-hole forming step B which will be described later. Specifically, it is more preferable that the specific gravity of the metal particles is 1.5 or more, and the specific gravity of the polymer component is 0.9 or more and less than 1.5.

(Surfactant)

From the viewpoint of coating properties, a nonionic surfactant as described in JP1987-251740A (JP-562-251740A) and/or JP1991-208514A (JP-H03-208514A) or an amphoteric surfactant as described in JP1984-121044A (JP-559-121044A) and/or JP1992-013149A (JP-H04-013149A) can be added to the composition.

Specific examples of the nonionic surfactant include sorbitan tristearate, sorbitan monopalmitate, sorbitan triolate, monoglyceride stearate, and/or polyoxyethylene nonyl phenyl ether.

Specific examples of the amphoteric surfactant include alkyl di(aminoethyl)glycine, alkyl polyaminoethyl glycine hydrochloride, 2-alkyl-N-carboxyethyl-N-hydroxyethylimidazolinium betaine, and/or N-tetradecyl-N,N-betaine type surfactant (for example, trade name AMOGEN K, manufactured by DKS Co., Ltd.).

In a case where the surfactant is contained, the content thereof is preferably 0.01% to 10% by mass and more preferably 0.05% to 5% by mass with respect to the total solid content contained in the composition.

(Solvent)

A solvent can be added to the composition from the viewpoint of workability in a case of forming the first masking layer and the second masking layer.

Specific examples of the solvent include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, y-butyrolactone, toluene, and water. These solvents may be used alone or in combination of two or more thereof

<Forming Method>

The method for forming a first masking layer using the above-mentioned composition is not particularly limited, but is preferably a method of applying the composition onto a metal foil to form the first masking layer.

The method of applying the composition onto the metal foil is not particularly limited, and a method such as a bar coating method, a slit coating method, an ink jet method, a spraying method, a roll coating method, a spin coating method, a casting coating method, a slit and spin method, or a transfer method can be used.

In the present invention, it is preferable to form the first masking layer so as to satisfy Expression (1) from the viewpoint that the formation of a through-hole becomes easy in the through-hole forming step B which will be described later.

n<r (1)

Here, in Expression (1), n represents the thickness of the first masking layer to be formed, r represents the average particle size of the metal particles contained in the composition, and the units of n and r both represent μm.

In addition, in the production method B-1, the thickness of the first masking layer formed by the first masking layer forming step is preferably 0.5 to 4 μm and preferably 1 μm or more and 2 μm or less, from the viewpoint of the resistance to an etchant used in the through-hole forming step B which will be described later and the workability in the masking layer removing step which will be described later.

Here, the average thickness of the first masking layer refers to an average value of thicknesses at any five points measured in a case where the first masking layer is cut using a microtome and the cross section is observed with an electron microscope.

[Second Masking Layer Forming Step]

Further, in the production method B-1, from the viewpoint of the workability in the through-hole forming step B which will be described later, it is preferable to include a second masking layer forming step of forming a second masking layer on the surface of the metal foil opposite to the surface on which the first masking layer is formed, using a composition containing a polymer component, before the through-hole forming step B.

Here, the polymer component may be the same as the polymer component contained in the composition which is used in the first masking layer forming step described above. That is, the second masking layer formed in an optional second masking layer forming step is the same layer as the above-mentioned first masking layer, except that the above-mentioned metal particles are not embedded therein. Also regarding the method of forming the second masking layer, the second masking layer can be formed in the same manner as in the above-mentioned first masking layer, except that the above-mentioned metal particles are not used.

In a case where the second masking layer forming step is provided, the order of carrying out the second masking layer forming step is not particularly limited as long as it is a step before the through-hole forming step B, and the second masking layer forming step may be a step which is carried out before, after, or simultaneously with the above-mentioned first masking layer forming step.

[Through-Hole Forming Step B]

The through-hole forming step B included in the production method B-1 is a step of bringing a metal foil having a first masking layer into contact with an etchant to dissolve a part of metal particles and metal foil, thereby forming through-holes in the metal foil, after the above-mentioned first masking layer forming step, and is a step of forming through-holes in the metal foil by a so-called chemical etching treatment.

<Etchant>

As the etchant, an acid or alkali chemical solution or the like can be appropriately used as long as it is an etchant suitable for a metal species of metal particles and metal foil.

Examples of the acid include hydrochloric acid, sulfuric acid, nitric acid, hydrofluoric acid, hydrogen peroxide, and acetic acid.

In addition, examples of the alkali include caustic soda and caustic potash.

In addition, examples of the alkali metal salt include alkali metal silicates such as sodium metasilicate, sodium silicate, potassium metasilicate, and potassium silicate; alkali metal carbonates such as sodium carbonate and potassium carbonate; alkali metal aluminates such as sodium aluminate and potassium aluminate; alkali metal aldonates such as sodium gluconate and potassium gluconate; and alkali metal hydrogen phosphates such as secondary sodium phosphate, secondary potassium phosphate, tertiary sodium phosphate, and tertiary potassium phosphate.

In addition, inorganic salts such as iron (III) chloride and copper (II) chloride can also be used.

In addition, these etchant compounds may be used alone or in combination of two or more thereof

<Treatment Method>

The treatment of forming a through-hole is carried out by bringing a metal foil having a first masking layer into contact with the above-mentioned etchant.

The method of bringing the metal foil into contact with the etchant is not particularly limited, and examples thereof include a dipping method and a spraying method. Above all, the dipping method is preferable.

The dipping treatment time is preferably 15 seconds to 10 minutes and more preferably 1 minute to 6 minutes.

In addition, the liquid temperature of the etchant at the time of dipping is preferably 25° C. to 70° C. and more preferably 30° C. to 60° C.

[Masking Layer Removing Step]

The masking layer removing step included in the production method B-1 is a step of removing the first masking layer (and the second masking layer, hereinafter collectively referred to as a masking layer) after the above-mentioned through-hole forming step B.

The method of removing the masking layer is not particularly limited, but in a case where the above-mentioned alkaline water-soluble polymer is used as the polymer component, a method of dissolving and removing the masking layer using an alkaline aqueous solution is preferable.

<Alkaline Aqueous Solution>

Specific examples of the alkaline aqueous solution include inorganic alkalis such as sodium hydroxide, potassium hydroxide, sodium carbonate, sodium silicate, sodium metasilicate, and aqueous ammonia; primary amines such as ethylamine and n-propylamine; secondary amines such as diethylamine and di-n-butylamine; tertiary amines such as triethylamine and methyldiethylamine; alcohol amines such as dimethylethanolamine and triethanolamine; quaternary ammonium salts such as tetramethylammonium hydroxide and tetraethylammonium hydroxide; and cyclic amines such as pyrrole and piperidine. These compounds may be used alone or in combination of two or more thereof.

In addition, an appropriate amount of alcohols or a surfactant can be added to the alkaline aqueous solution for use.

<Treatment Method>

The treatment of removing the masking layer is carried out, for example, by bringing the metal foil having a masking layer after the through-hole forming step B into contact with the above-mentioned alkaline aqueous solution.

The method of bringing the metal foil into contact with the alkaline aqueous solution is not particularly limited, and examples thereof include a dipping method and a spraying method. Above all, the dipping method is preferable.

The dipping treatment time is preferably 5 seconds to 5 minutes and more preferably 10 seconds to 2 minutes.

In addition, the temperature of the alkaline aqueous solution at the time of dipping is preferably 25° C. to 60° C. and more preferably 30° C. to 50° C.

[Anti-Corrosion Treatment]

The production method B-1 preferably includes a step of carrying out an anti-corrosion treatment.

In addition, the timing at which the anti-corrosion treatment is carried out is not particularly limited, and the anti-corrosion treatment may be, for example, a treatment to be carried out on the metal foil which is used in the first masking layer forming step, or may be a treatment in which triazoles or the like described later is added to the alkaline aqueous solution in the masking layer removing step, or may be a treatment to be carried out after the masking layer removing step.

The anti-corrosion treatment may be, for example, a treatment in which a metal foil is dipped in a solution having at least triazoles dissolved in a solvent and having a pH of 5 to 8.5 to form an organic dielectric film.

Suitable examples of triazoles include benzotriazole (BTA) and tolyltriazole (TTA).

In addition to the triazoles, various organic rust inhibitors, thiazoles, imidazoles, mercaptans, and/or triethanolamines can also be used.

Water or an organic solvent (particularly, alcohols) can be appropriately used as the solvent for use in the anti-corrosion treatment, but water mainly composed of deionized water is preferable in consideration of the uniformity of the organic dielectric film to be formed, easy control of the thickness during mass production, convenience, and the environmental impact.

The dissolution concentration of triazoles is appropriately determined in relation to the thickness of the organic dielectric film to be formed and the treatable time, but may be usually about 0.005% to 1% by weight.

In addition, the temperature of the solution may be room temperature, but the solution may be used after being heated if necessary.

The dipping time of the metal foil in the solution is appropriately determined in relation to the dissolution concentration of the triazoles and the thickness of the organic dielectric film to be formed, but may be usually about 0.5 to 30 seconds.

Another specific example of the anti-corrosion treatment may be a method of forming an inorganic dielectric film mainly composed of a hydrated oxide of chromium by dipping a metal foil in an aqueous solution which is obtained by dissolving at least one selected from the group consisting of chromium trioxide, chromate, and dichromate in water.

Here, for example, potassium chromate and sodium chromate are suitable as the chromate, and for example, potassium dichromate and sodium dichromate are suitable as the dichromate. The dissolution concentration thereof is usually set to 0.1% to 10% by mass, and the liquid temperature may be about room temperature to 60° C. The pH value of the aqueous solution is not particularly limited from an acidic region to an alkaline region, but is usually set to 1 to 12.

In addition, the dipping time of the metal foil is appropriately selected depending on the thickness of the inorganic dielectric film to be formed or the like.

In the present invention, it is preferable to carry out washing with water after the completion of steps of each treatment described above. Pure water, well water, and/or tap water can be used for washing with water. A nip device may be used to prevent the treatment liquid from being brought into the next step.

Here, the method B for producing a metal foil is not limited to the above-mentioned method.

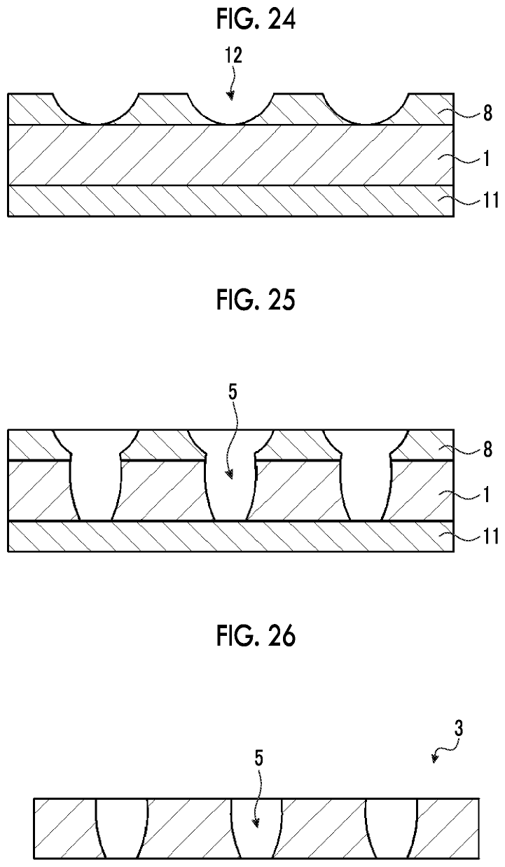

The production method B-1 is set to have a configuration in which, after the first masking layer forming step, the through-hole forming step B is carried out to bring a part of metal particles and metal foil into contact with an etchant and dissolve them to form through-holes in the metal foil, but the method B for producing a metal foil is not limited thereto. As shown in FIG. 22 to FIG. 26, the method B for producing a metal foil may have a configuration in which a particle removing step (FIG. 24) of removing particles is carried out after the first masking layer forming step (FIG. 22), or further after the second masking layer forming step (FIG. 23) and before the through-hole forming step, then the through-hole forming step B (FIG. 24 and FIG. 25) is carried out, and then the masking layer removing step (FIG. 25 and FIG. 26) is carried out (hereinafter, also referred to as “production method B-2”). In this case, the particles contained in the first masking layer are not limited to metal particles, and mineral fillers, inorganic-organic composite fillers, and the like can be used.

As described above, the first masking layer 8 in which a concave portion 12 is formed in the portion where particles 9 are embedded is obtained through the first masking layer forming step and the particle removing step, and in the subsequent through-hole forming step B, the through-hole 5 is formed starting from the concave portion 12 of the first masking layer 8. Regarding the reason why the through-hole 5 is formed starting from the concave portion 12 of the first masking layer 8, it is considered that, in the deepest portion of the concave portion 12, an extremely thin first masking layer 8 remains, or there is a portion where the metal foil 1 is exposed, so that the etchant penetrates from the concave portion 12 preferentially over other portions and therefore the through-hole 5 is formed in the metal foil 1.

Examples of the mineral filler contained in the first masking layer include a metal and a metal compound. Examples of the metal compound include an oxide, a composite oxide, a hydroxide, a carbonate, a sulfate, a silicate, a phosphate, a nitride, a carbide, a sulfide, and a composite of at least two or more thereof.

Specific examples of the mineral filler include glass, zinc oxide, silica, alumina, zirconium oxide, tin oxide, potassium titanate, strontium titanate, aluminum borate, magnesium oxide, magnesium borate, aluminum hydroxide, magnesium hydroxide, calcium hydroxide, titanium hydroxide, basic magnesium sulfate, calcium carbonate, magnesium carbonate, calcium sulfate, magnesium sulfate, calcium silicate, magnesium silicate, calcium phosphate, silicon nitride, titanium nitride, aluminum nitride, silicon carbide, titanium carbide, zinc sulfide, and a composite of at least two or more thereof.

Of these, glass, silica, alumina, potassium titanate, strontium titanate, aluminum borate, magnesium oxide, calcium carbonate, magnesium carbonate, calcium silicate, magnesium silicate, calcium phosphate, and calcium sulfate are preferable.

The inorganic-organic composite filler may be, for example, a composite in which the surface of a particle such as a synthetic resin particle or a natural polymer particle is coated with the above-mentioned mineral filler.

Specific examples of the synthetic resin particle include particles of resins such as acrylic resin, polyethylene, polypropylene, polyethylene oxide, polypropylene oxide, polyethylene imine, polystyrene, polyurethane, polyurea, polyester, polyamide, polyimide, carboxymethyl cellulose, gelatin, starch, chitin, and chitosan.

Of these, acrylic resin, polyethylene, polypropylene, and polystyrene resin particles are preferable.

In the particle removing step, the method of removing the particles is not particularly limited. For example, as shown in FIG. 22, in a case where the first masking layer is in a state where a part of each of the particles is embedded, the particles can be removed by applying an external force using a sponge, a brush, or the like to the portion of the particle that is not embedded in the first masking layer.

In the present invention, the method of removing the particles is preferably a method of removing the particles by rubbing the surface of the first masking layer in which at least a part of each of the particles is embedded while being dipped in a solvent, because the shape of the first masking layer is not changed and the particles can be removed quickly.

Here, the “surface of the first masking layer in which at least a part of each of the particles is embedded” refers to the surface of each particle and the first masking layer in a case where a part of each particle is embedded in the first masking layer as shown in FIG. 22, and refers to the surface of the first masking layer in a case where all of the particles are embedded in the first masking layer.

The solvent is not particularly limited as long as it dissolves the first masking layer, and for example, the same solvent as the solvent described as an optional component of the composition used in the above-mentioned first masking layer forming step can be used.

In addition, the method of rubbing the surface of the first masking layer is not particularly limited and may be, for example, a method of rubbing with a sponge or a brush (for example, a wire brush or a nylon brush roll).

In addition, in the method for producing a metal foil having through-holes, as a method for forming through-holes in the metal foil, there is a method in which a metal foil is brought into contact with an etchant to locally cause dissolution starting from an intermetallic compound (precipitate or crystallized product) in the metal foil to form through-holes. In a case of this method, since the existence status of the intermetallic compound differs depending on the material of the metal foil, conditions may be set in advance for each material, and conditions such as etchant conditions and etching time may be adjusted. In this case, the masking layer can be eliminated.

[Roll-to-Roll Treatment]

In the present invention, the production method may be a method in which the treatment of each step is carried out in a so-called single-sheet method using a cut sheet-like metal foil, or may be a method in which a long metal foil is transported in a predetermined transport path in a longitudinal direction and the treatment of each step is carried out, that is, a method of carrying out a so-called roll-to-roll (hereinafter, also referred to as “RtoR”) treatment.

RtoR in the present invention is a production method in which a metal foil is sent out from a roll formed by winding a long metal foil; while the metal foil being transported in a longitudinal direction, the above-mentioned steps are continuously and sequentially carried out by each of the treatment devices arranged on the transport path; and the treated metal foil is wound again into a roll.

### EXAMPLES

Hereinafter, the present invention will be described in more detail based on the Examples. The materials, the amounts of materials used, the proportions, the treatment details, the treatment procedure, or the like shown in the Examples below may be appropriately modified without departing from the spirit of the present invention. Therefore, the scope of the present invention should not be construed as being limited to the Examples set forth below.

### Example 1

<Production of Metal Foil Having Through-Holes>

An aluminum foil (JISH-4160, alloy number: 1N30-H, aluminum purity: 99.30%) having an average thickness of 20 μm and a size of 200 mm×300 mm was used as the metal foil.

The aluminum foil was subjected to the following treatment to form through-holes.

(a1) Aluminum Hydroxide Film Forming Treatment (Film Forming Step)

An aluminum hydroxide film was formed on the surface of the aluminum foil using an electrolytic solution (nitric acid concentration: 1%, sulfuric acid concentration: 0.2%, aluminum concentration: 0.5%) kept at 50° C. and using the aluminum foil as a cathode. The electrolytic treatment was carried out with a direct-current power source. The direct current density was 15 A/dm², and the current was applied for 30 seconds.

The formation of the aluminum hydroxide film was followed by washing with water by spraying.

(b1) Electrolytic Dissolution Treatment (Through-Hole Forming Step A)

Next, using an electrolytic solution (nitric acid concentration: 1%, sulfuric acid concentration: 0.2%, aluminum concentration: 0.5%) kept at 50° C., and an aluminum foil as an anode, an electrolytic treatment was carried out under the conditions of a current density of 22 A/dm² and a total electric quantity of 1000 C/dm² to form through-holes in the aluminum foil and the aluminum hydroxide film. The electrolytic treatment was carried out with a direct-current power source.

The formation of the through-holes was followed by washing with water by spraying and then drying.

(c1) Aluminum Hydroxide Film Removing Treatment (Film Removing Step)

Next, the aluminum foil after the electrolytic dissolution treatment was dipped in an aqueous solution (liquid temperature: 35° C.) having a sodium hydroxide concentration of 5% by mass and an aluminum ion concentration of 0.5% by mass for 30 seconds, and then dipped in an aqueous solution (liquid temperature: 50° C.) having a sulfuric acid concentration of 30% and an aluminum ion concentration of 0.5% by mass for 20 seconds, whereby the aluminum hydroxide film was dissolved and removed.

This was followed by washing with water by spraying and then drying to produce an aluminum foil having through-holes.

With respect to the produced metal foil, the average opening ratio determined by the through-holes and the average opening diameter of the through-holes were measured by the above-mentioned method.

In addition, the light transmittance of the produced metal foil was measured by the above-mentioned method.

The results are shown in Table 2 below.

<Formation of Protective Layer>

Protective layer reactants were prepared and stirred for 60 minutes, and methanol was added thereto to obtain a protective layer composition 1.

The protective layer composition 1 was applied onto one surface of the aluminum foil produced above and dried at 120° C. for 10 minutes to form a protective layer having a thickness of about 1 μm.

Protective layer composition 1

| | |
|---|---|
| Tetraethyl silicate | 50.0 parts by mass |
| Methanol | 10.8 parts by mass |
| Water | 86.4 parts by mass |
| Phosphoric acid (85%) | 0.08 parts by mass |

In addition, in a case where a protective layer was formed on a transparent support using the protective layer composition 1 and the light transmittance was measured, the measured value was 90%.

### Example 2

<Production of Metal Foil Having Through-Holes>

A copper foil (JISC 1100-H, electrolytic copper foil) having an average thickness of 10 μm and a size of 200 mm×300 mm was used as the metal foil.

The copper foil was subjected to the following treatment to form through-holes.

(d1) First Masking Layer Forming Step

A composition 1 for forming a masking layer prepared to have the following composition was applied onto one surface of the copper foil and dried to form a first masking layer A1 having a thickness of about 1 μm.

In addition, a composition prepared in the same ratio as the following composition 1 for forming a masking layer except for removing copper particles was applied onto the opposite surface of the copper foil and dried to form a second masking layer B1 having a thickness of about 1 μm.

Composition 1 for forming masking layer

| m, p-Cresol novolac | 1.2 parts by mass |
|---|---|
| (m/p ratio = 6/4, weight-average molecular weight: 4100) | |
| HXR-Cu | 0.4 parts by mass |
| (copper particles, average particle size: 5.0 μm, manufactured | |
| by Nippon Atomized Metal Powders Corporation) | |
| MEGAFACE F-780-F | 0.1 parts by mass |
| (surfactant, manufactured by DIC Corporation) | |
| Methyl ethyl ketone | 1.0 part by mass |
| 1-Methoxy-2-propanol | 5.0 parts by mass |

(e1) Through-Hole Forming Step B

Next, an etchant (iron (III) chloride concentration: 30% by mass, hydrochloric acid concentration: 3.65% by mass) kept at 40° C. was sprayed onto the copper foil having the first masking layer A1 and the second masking layer B1 by spraying for 120 seconds, which was followed by washing with water by spraying and then drying to form through-holes.

(f1) Masking Layer Removing Step

Next, the first masking layer A1 and the second masking layer B1 were dissolved and removed by dipping the copper foil after the formation of the through-holes in an alkaline aqueous solution (sodium hydroxide concentration: 0.4% by mass) at a liquid temperature of 50° C. for 120 seconds.

This was followed by washing with water by spraying and then drying to produce a metal foil (copper foil) having through-holes.

<Formation of Protective Layer>

A protective layer was formed on one surface of the produced metal foil (copper foil) in the same manner as in Example 1 above.

### Example 3

A laminate was produced in the same manner as in Example 1, except that the thickness of the metal foil was 10 μm; in (b1) electrolytic dissolution treatment (through-hole forming step A), the current density during the electrolytic treatment was 35 A/dm² and the total electric quantity was 380 C/dm²; and in (c1) aluminum hydroxide film removing treatment (film removing step), the sodium hydroxide concentration in an aqueous solution was 35% by mass and a resin layer was formed by the following method on the surface of the metal foil opposite to the surface on which the protective layer was formed.

<Formation of Resin Layer>

A PET having a thickness of 100 μm was laminated as a resin layer on the surface of the aluminum foil having through-holes and on which the protective layer was not formed, by the method described in JP2013-121673A. The thickness of the resin layer was 100 μm. The thickness of the resin layer after the lamination was 100 μm.

### Example 4

A laminate was produced in the same manner as in Example 3, except that a protective layer was formed using a protective layer composition 2 below.

Protective layer composition 2

| Tetraethyl silicate | 30.0 parts by mass |
|---|---|
| Titanium oxide PT501-A | 20.0 parts by mass |
| (manufactured by Ishihara Sangyo Kaisha, Ltd.) | |
| Methanol | 10.8 parts by mass |
| Water | 86.4 parts by mass |
| Phosphoric acid (85%) | 0.08 parts by mass |

In addition, in a case where a protective layer was formed on a transparent support using the protective layer composition 2 and the light transmittance was measured, the measured value was 50%.

### Example 5

A laminate was produced in the same manner as in Example 3, except that the thickness of the protective layer was 10 μm.

The light transmittance of the protective layer was measured and found to be 80%.

### Example 6

A laminate was produced in the same manner as in Example 3, except that a protective layer was formed using a protective layer composition 3 below.

Protective layer composition 3

| Tetraethyl silicate | 20.0 parts by mass |
|---|---|
| Titanium oxide PT501-A | 30.0 parts by mass |
| (manufactured by Ishihara Sangyo Kaisha, Ltd.) | |
| Methanol | 10.8 parts by mass |
| Water | 86.4 parts by mass |
| Phosphoric acid (85%) | 0.08 parts by mass |

In addition, in a case where a protective layer was formed on a transparent support using the protective layer composition 3 and the light transmittance was measured, the measured value was 30%.

### Example 7

A laminate was produced in the same manner as in Example 3, except that a protective layer consisting of a protective layer composition 4 below was formed.

| Protective layer composition 4 | |
|---|---|
| Tetranormal butyl titanate | 50.0 parts by mass |
| (TA-21, manufactured by Matsumoto Fine Chemicals Co., Ltd.) | |
| 2-Propanol | 86.4 parts by mass |
| Water | 10.8 parts by mass |
| Phosphoric acid (85%) | 0.08 parts by mass |

In addition, in a case where a protective layer was formed on a transparent support using the protective layer composition 4 and the light transmittance was measured, the measured value was 90%.

### Comparative Example 1

A metal foil (aluminum foil) was produced in the same manner as in Example 3, except that a protective layer was not formed.

### Comparative Example 2

A laminate was produced in the same manner as in Example 3, except that a protective layer consisting of a protective layer composition 5 below, containing no metal oxide, was formed as the protective layer.

Protective layer composition 5

| Polymethyl methacrylate | 5.0 parts by mass |
|---|---|
| (PMMA, manufactured by Sigma-Aldrich, LLC., weight-average | |
| molecular weight: about 15000) | |
| Ethanol | 20.0 parts by mass |

### Comparative Example 3

A laminate was produced in the same manner as in Comparative Example 2, except that the thickness of the protective layer was 10 μm.

[Evaluation]

The produced laminates of Examples and Comparative Examples were evaluated for light-transmitting properties, metallic luster, scratch resistance, weather fastness, and solvent resistance.

<Light-Transmitting Properties>

The light transmittance of the laminate in a wavelength range of 200 nm to 900 nm was measured.

The light transmittance was measured using NDH4000 (manufactured by Nippon Denshoku Industries Co., Ltd.) in accordance with JISK 7361.

<Metallic Luster>

The appearance of the surface of the laminate on the side where the protective layer was formed (the surface of the metal foil in Comparative Example 1) was visually evaluated. The case where it was the same as the original metal was evaluated as A; the case where some turbidity was observed was evaluated as B; the case where the discoloration was dull and the metallic luster was slightly reduced was evaluated as C; and the case where shine was generated and no metallic luster was observed was evaluated as D.

<Scratch Resistance>

A pencil hardness test was carried out on the surface of the laminate on the side where the protective layer was formed in accordance with JISK 5600-5-4, and the hardness immediately before the scratch was visually observed was examined.

<Weather Fastness>

An accelerated weather fastness test (2000 hours) was carried out on the laminates of Examples and Comparative Examples in accordance with JISK 7350-4, and then the light transmittance was measured to determine a ratio to the light transmittance before the test. In a case where the ratio to the light transmittance before the test was 90% or more, it was evaluated as A; in a case where the ratio to the light transmittance before the test was less than 90% to 80% or more, it was evaluated as B; and in a case where the ratio to the light transmittance before the test was less than 80%, it was evaluated as C.

In addition, the appearance of the surface (metallic luster) of the laminate on the side where the protective layer was formed after the test was visually evaluated based on the same standards as described above.

<Solvent Resistance>

The laminates of Examples and Comparative Examples were dipped in ethanol diluted to 50% with acetone and water at room temperature for 60 minutes, and then the light transmittance was measured to determine a ratio to the light transmittance before the test. In a case where the ratio to the light transmittance before the test was 90% or more, it was evaluated as A; in a case where the ratio to the light transmittance before the test was less than 90% to 80% or more, it was evaluated as B; and in a case where the ratio to the light transmittance before the test was less than 80%, it was evaluated as C.

The results are shown in Table 3.

TABLE 2

| | Metal foil | | | | | |
|---|---|---|---|---|---|---|
| | | | Through-hole | | | |
| | | | Average | Average | Protective layer | |
| | | | opening | opening | | Light |
| | | Thickness | ratio | diameter | Thickness | transmittance |
| | Type | μm | % | μm | μm | % |
| Example 1 | Aluminum foil | 20 | 15 | 40 | 1 | 90 |
| Example 2 | Copper foil | 10 | 5 | 10 | 1 | 90 |
| Example 3 | Aluminum foil | 10 | 30 | 20 | 1 | 90 |
| Example 4 | Aluminum foil | 10 | 30 | 20 | 1 | 50 |
| Example 5 | Aluminum foil | 10 | 30 | 20 | 10 | 80 |
| Example 6 | Aluminum foil | 10 | 30 | 20 | 1 | 30 |
| Example 7 | Aluminum foil | 10 | 30 | 20 | 1 | 90 |
| Comparative | Aluminum foil | 10 | 30 | 20 | — | — |
| Example 1 | | | | | | |
| Comparative | Aluminum foil | 10 | 30 | 20 | 1 | 90 |
| Example 2 | | | | | | |
| Comparative | Aluminum foil | 10 | 30 | 20 | 10 | 80 |
| Example 3 | | | | | | |

TABLE 3

| | Evaluation | | | | | |
|---|---|---|---|---|---|---|
| | Light-transmitting | | | | | |
| | properties | | Scratch | | | Solvent |
| | Light | | resistance | Weather fastness | | resistance |
| | transmittance | Metallic | Pencil | Ratio of light | Metallic | Ratio of light |
| | % | luster | hardness | transmittance | luster | transmittance |
| Example 1 | 14 | A | 8H | A | A | A |
| Example 2 | 5 | A | 8H | A | A | A |
| Example 3 | 28 | A | 8H | A | A | A |
| Example 4 | 15 | B | 8H | A | B | A |
| Example 5 | 24 | B | 8H | A | B | A |
| Example 6 | 10 | C | 8H | A | C | A |
| Example 7 | 28 | A | 8H | A | A | A |
| Comparative | 30 | A | 4B↓ | A | C | A |
| Example 1 | | | | | | |
| Comparative | 28 | B | 2H | C | C | C |
| Example 2 | | | | | | |
| Comparative | 23 | D | 2H | B | D | B |
| Example 3 | | | | | | |

From Table 2 and Table 3, it can be seen that, in a case where the metal foil is exposed as in Comparative Example 1, the scratch resistance is low and the metallic luster is lost over time in a natural environment. In addition, in a case of Comparative Example 2 in which a thin resin layer (resin layer containing no metal oxide) is provided, it can be seen that sufficient weather fastness and solvent resistance cannot be obtained because the resin layer is thin. In addition, in a case of Comparative Example 3 in which a thick resin layer is provided, it can be seen that the metallic luster is lost because the resin layer is thick.

On the other hand, in Examples of the present invention in which a protective layer containing a metal oxide is provided on the surface of the metal foil, as compared with Comparative Examples, it can be seen that both light-transmitting properties and metallic luster can be achieved, and scratch resistance, weather fastness, and solvent resistance are high.

In addition, from the comparison of Example 3, Example 4, and Example 6, it can be seen that the light transmittance of the protective layer is preferably 50% or more and more preferably 90% or more.

In addition, from the comparison between Example 3 and Example 5, it can be seen that the thickness of the protective layer is preferably 10 μm or less.

The effect of the present invention is clear from the above results.

### EXPLANATION OF REFERENCES

1: metal foil (aluminum foil)
2: aluminum hydroxide film
3: metal foil having through-holes (aluminum foil having through-holes)
4: aluminum hydroxide film having through-holes
5: through-hole
6: resin layer
7: protective layer
8: first masking layer
9: particle (metal particle)
10a to 10c: laminate
11: second masking layer
12: concave portion

What is claimed is:

1. A laminate comprising:
a metal foil having a plurality of through-holes that pass through in a thickness direction; and
a protective layer provided on at least one surface of the metal foil,
wherein the protective layer contains a metal oxide,
the metal foil has an average opening diameter of the through-holes of 0.1 to 100 μm and an average opening ratio, which is determined by the through-holes, of 0.1% to 90%, and
the protective layer has a light transmittance of 10% or more.

2. The laminate according to claim 1,
wherein the protective layer is provided on one surface of the metal foil, and
the laminate has a resin layer provided on a surface of the metal foil opposite to the surface on which the protective layer is provided.

3. The laminate according to claim 1,
wherein a content of the metal oxide in the protective layer is 60% by mass or more with respect to a total mass of the protective layer.

4. The laminate according to claim 1,
wherein the protective layer is formed by a sol-gel method.

5. The laminate according to claim 1,
wherein the protective layer has an average thickness of 0.01 μm to 10 μm.

6. The laminate according to claim 1,
wherein the metal foil has an average thickness of 5 μm to 1,000 μm.

7. The laminate according to claim 1,
wherein the metal foil is a foil selected from the group consisting of an aluminum foil, a copper foil, a silver foil, a gold foil, a platinum foil, a stainless steel foil, a titanium foil, a tantalum foil, a molybdenum foil, a niobium foil, a zirconium foil, a tungsten foil, a beryllium copper foil, a phosphor bronze foil, a brass foil, a nickel silver foil, a tin foil, a lead foil, a zinc foil, a solder foil, an iron foil, a nickel foil, a Permalloy foil, a nichrome foil, an Alloy 42 foil, a Kovar foil, a Monel foil, an Inconel foil, and a Hastelloy foil, or a foil obtained by laminating a foil selected from the above group and a metal of a type different from the selected foil.

8. The laminate according to claim 2,
wherein a content of the metal oxide in the protective layer is 60% by mass or more with respect to a total mass of the protective layer.

9. The laminate according to claim 2,
wherein the protective layer is formed by a sol-gel method.

10. The laminate according to claim 2,
wherein the protective layer has an average thickness of 0.01 μm to 10 μm.

11. The laminate according to claim 2,
wherein the metal foil has an average thickness of 5 μm to 1,000 μm.

12. The laminate according to claim 2,
wherein the metal foil is a foil selected from the group consisting of an aluminum foil, a copper foil, a silver foil, a gold foil, a platinum foil, a stainless steel foil, a titanium foil, a tantalum foil, a molybdenum foil, a niobium foil, a zirconium foil, a tungsten foil, a beryllium copper foil, a phosphor bronze foil, a brass foil, a nickel silver foil, a tin foil, a lead foil, a zinc foil, a solder foil, an iron foil, a nickel foil, a Permalloy foil, a nichrome foil, an Alloy 42 foil, a Kovar foil, a Monel foil, an Inconel foil, and a Hastelloy foil, or a foil obtained by laminating a foil selected from the above group and a metal of a type different from the selected foil.

13. The laminate according to claim 3,
wherein the protective layer is formed by a sol-gel method.

14. The laminate according to claim 3,
wherein the protective layer has an average thickness of 0.01 μm to 10 μm.

15. The laminate according to claim 3,
wherein the metal foil has an average thickness of 5 μm to 1,000 μm.

16. The laminate according to claim 3,
wherein the metal foil is a foil selected from the group consisting of an aluminum foil, a copper foil, a silver foil, a gold foil, a platinum foil, a stainless steel foil, a titanium foil, a tantalum foil, a molybdenum foil, a niobium foil, a zirconium foil, a tungsten foil, a beryllium copper foil, a phosphor bronze foil, a brass foil, a nickel silver foil, a tin foil, a lead foil, a zinc foil, a solder foil, an iron foil, a nickel foil, a Permalloy foil, a nichrome foil, an Alloy 42 foil, a Kovar foil, a Monel foil, an Inconel foil, and a Hastelloy foil, or a foil obtained by laminating a foil selected from the above group and a metal of a type different from the selected foil.

17. The laminate according to claim 4,
wherein the protective layer has an average thickness of 0.01 μm to 10 μm.

18. The laminate according to claim 4,
wherein the metal foil has an average thickness of 5 μm to 1,000 μm.

19. The laminate according to claim 4,
wherein the metal foil is a foil selected from the group consisting of an aluminum foil, a copper foil, a silver foil, a gold foil, a platinum foil, a stainless steel foil, a titanium foil, a tantalum foil, a molybdenum foil, a niobium foil, a zirconium foil, a tungsten foil, a beryllium copper foil, a phosphor bronze foil, a brass foil, a nickel silver foil, a tin foil, a lead foil, a zinc foil, a solder foil, an iron foil, a nickel foil, a Permalloy foil, a nichrome foil, an Alloy 42 foil, a Kovar foil, a Monel foil, an Inconel foil, and a Hastelloy foil, or a foil obtained by laminating a foil selected from the above group and a metal of a type different from the selected foil.

20. The laminate according to claim 5,
wherein the metal foil has an average thickness of 5 μm to 1,000 μm.
